(19) United States
(12) Patent Application Publication
(10) Pub. No.: US 2008/0143751 A1
(43) Pub. Date: Jun. 19, 2008

(54) APPARATUS, METHOD, AND COMPUTER PROGRAM FOR DISPLAYING IMAGE, AND APPARATUS, METHOD, AND COMPUTER PROGRAM FOR PROVIDING IMAGE, AND RECORDING MEDIUM

(76) Inventor: Yoshihiro Chosokabe, Nagano (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/943,198

(22) Filed: Nov. 20, 2007

(30) Foreign Application Priority Data
Dec. 13, 2006 (JP) P2006-336176

(51) Int. Cl. G09G 5/00

(52) U.S. Cl. 345/654

(57) ABSTRACT

A display apparatus includes a recorder for recording a plurality of two-dimensional images that are obtained with a three-dimensional image viewed from different viewpoints, the three-dimensional image having a plurality of content indicators representing contents and arranged in three-dimensional coordinates representing first through third impression values of impression at each content, a display for displaying the two-dimensional image recorded on the recorder, a pointer for pointing to the viewpoint for modification to view the three-dimensional image, and a display controller for reading from the recorder one of two-dimensional images with the three-dimensional image viewed from one viewpoint, reading from the recorder another two-dimensional image with the three-dimensional image viewed from another viewpoint in response to an operation input entered to the pointer with the read two-dimensional image being displayed on the display, and displaying the other read two-dimensional image on the display.

### CROSS REFERENCES TO RELATED APPLICATIONS

The present invention contains subject matter related to Japanese Patent Application JP 2006-336176 filed in the Japanese Patent Office on Dec. 13, 2006, the entire contents of which are incorporated herein by reference.

### BACKGROUND OF THE INVENTION

1. Field of the Invention

The present invention relates to a display apparatus, a display method, a display computer program, an image providing apparatus, an image providing method, an image providing computer program and a recording medium, appropriate for use in a music selection system for allowing desired music to be selected.

2. Description of the Related Art

Known song search apparatuses digitize impression of a plurality of songs into two-dimensional data impression values, each value being represented as a point in a two-dimensional image. Such a song search apparatus selects each point in the two-dimensional image as disclosed in Japanese Unexamined Patent Application Publication No. 2005-10771.

### SUMMARY OF THE INVENTION

Current song search apparatuses handle three types of impression values of each song in three-dimensional coordinates and generate a three dimensional image. The three-dimensional image is composed of indicators, each representing a respective song in three-dimensional coordinates. Such a song search apparatus generates a two-dimensional image by projecting the three-dimensional image onto a two-dimensional plane as if the three-dimensional image is viewed from a predetermined viewpoint. The generated two-dimensional image is displayed on a display. This arrangement allows a user to recognize intuitively what impression of songs are selectable. Each point in the two-dimensional image is thus selected as a song.

In such a song search apparatus, a plurality of indicators in the three-dimensional image are arranged in response to the impression of each of the plurality of songs. At least two indicators can overlay each other within the two-dimensional image generated based on the three-dimensional image. If at least two indicators overlay each other within the two-dimensional image in such a song search apparatus, an indicator placed behind the other indicator from the viewpoint within the three-dimensional image cannot be displayed in the two-dimensional image and cannot be selected.

The song search apparatus modifies the viewpoint to view the three-dimensional image in response to an instruction from a user. The two-dimensional image may be re-generated in response to the modification of the viewpoint and displayed on the display. In the song search apparatus, at least two indicators are overlaid on each other within the two-dimensional image generated with the three-dimensional image viewed from a given viewpoint. The two indicators then are not overlaid on each other within a two-dimensional image with the three-dimensional image viewed from another viewpoint. By switching the two-dimensional images appropriately, any indicator can be selectively displayed to the user.

The user instructs such a song search apparatus to modify the viewpoint to view the three-dimensional image and in response the two-dimensional image is switched and displayed to the user. At each of such operations, a complex process are performed. For example, a two-dimensional image having a different viewpoint is generated from the three-dimensional image. The song search apparatus has difficulty displaying to the user the two-dimensional image indicating the impression of each of the plurality of songs.

It is thus desirable to provide a display apparatus, a display method, a display computer program, an image providing apparatus, an image providing method, an image providing computer program and a recording medium, for displaying easily to the user a two-dimensional image indicating the impression of each content.

In accordance with one embodiment of the present invention, a display apparatus includes a recorder for recording a plurality of two-dimensional images that are obtained with a three-dimensional image viewed from different viewpoints, the three-dimensional image having a plurality of content indicators representing contents and arranged in three-dimensional coordinates representing first through third impression values of impression at each content, a display for displaying the two-dimensional image recorded on the recorder, a pointer for pointing to the viewpoint for modification to view the three-dimensional image, and a display controller for reading from the recorder one of two-dimensional images with the three-dimensional image viewed from one viewpoint, reading from the recorder another two-dimensional image with the three-dimensional image viewed from another viewpoint in response to an operation input entered to the pointer with the read two-dimensional image being displayed on the display, and displaying the other read two-dimensional image on the display.

In accordance with the embodiment of the present invention, the plurality of two-dimensional images are generated and prepared with the three-dimensional image viewed from the different viewpoints. In response to the instruction to modify the viewpoint to view the three-dimensional image, the two-dimensional image responsive to the modified viewpoint is selected from the prepared two-dimensional images and displayed on the display. With this arrangement, process workload involved in switching the two-dimensional images generated with the three-dimensional image viewed from the different viewpoints is substantially reduced.

In accordance with one embodiment of the present invention, an image providing apparatus includes a recorder for recording a plurality of two-dimensional images that are obtained with a three-dimensional image viewed from different viewpoints, the three-dimensional image having a plurality of content indicators representing contents and arranged in three-dimensional coordinates representing first through third impression values of impression at each content, a communicator for communicating with an external device, and a controller for reading from the recorder one of two-dimensional images with the three-dimensional image viewed from one viewpoint, causing the communicator to transmit the one of two-dimensional images to the external device, reading from the recorder another two-dimensional image with the three-dimensional image viewed from another viewpoint if the communicator receives an operation input from the external device with the read two-dimensional image being displayed on a display, and causing the communicator to transmit to the external device the other read two-dimensional image.

In accordance with the embodiment of the present invention, the plurality of two-dimensional images are generated and prepared with the three-dimensional image viewed from the different viewpoints. In response to the instruction to modify the viewpoint to view the three-dimensional image, the two-dimensional image responsive to the modified viewpoint is selected from the prepared two-dimensional images and then transmitted to the external device. With this arrangement, process workload involved in switching the two-dimensional image generated with the three-dimensional image viewed from the different viewpoints and transmitting the selected two-dimensional image to the external device is substantially reduced.

In accordance with embodiments of the present invention, the recorder records the plurality of two-dimensional images that are obtained with the three-dimensional image viewed from different viewpoints, the three-dimensional image having a plurality of content indicators representing contents and arranged in three-dimensional coordinates representing first through third impression values of impression at each content. The display controller reads the two-dimensional image from the recorder. The instruction to modify the viewpoint is issued from the pointer with one of two-dimensional images displayed on the display. In response to the instruction, the two-dimensional image is generated with the three-dimensional image viewed from the modified viewpoint and read from the recorder. The read two-dimensional image is then displayed on the display. In this way, the process workload involved in switching the two-dimensional images generated with the three-dimensional image viewed from the different viewpoints and viewing the selected two-dimensional image is substantially reduced. The display apparatus, display method, display program and recording medium for easily displaying the two-dimensional image showing the impression of each content are thus provided.

In accordance with embodiments of the present invention, the recorder records the plurality of two-dimensional images that are obtained with the three-dimensional image viewed from different viewpoints, the three-dimensional image having a plurality of content indicators representing contents and arranged in three-dimensional coordinates representing first through third impression values of impression at each content. The transmission controller reads from the recorder the two-dimensional image generated with the three-dimensional image viewed from a predetermined viewpoint from among the plurality of two-dimensional images. The transmission controller transmits the read two-dimensional image from the communicator to the external device. The communicator receives request information transmitted from the external device displaying the two-dimensional image. The request information requests that the viewpoint for viewing the three-dimensional image be modified. The transmission controller reads from the recorder the two-dimensional image that is generated with the three-dimensional image viewed from a modified viewpoint indicated by the received request information. The transmission controller transmits the read two-dimensional image from the communicator to the external device. With this arrangement, the process workload involved in switching the two-dimensional images generated with the three-dimensional image viewed from the different viewpoints and transmitting the selected two-dimensional image to the external device is substantially reduced. The image providing apparatus, image providing method, image providing program and recording medium for easily displaying the two-dimensional image showing the impression of each content are thus provided.

### BRIEF DESCRIPTION OF THE DRAWINGS

FIG. 1 is a block diagram of a display apparatus in accordance with one embodiment of the present invention;

FIG. 2 is a block diagram illustrating an image providing apparatus in accordance with one embodiment of the present invention;

FIG. 3 is a configuration chart of a music selection system in accordance with one embodiment of the present invention;

FIG. 4 is a block diagram illustrating in detail a data recording and playing apparatus in accordance with one embodiment of the present invention;

FIG. 5 lists three types of impression of music;

FIG. 6 illustrates music analysis information;

FIG. 7 illustrates a three-dimensional image;

FIG. 8 illustrates a viewpoint used to generate a music selection image from the three-dimensional image;

FIGS. 9A-9D illustrate a perspective expression in accordance with location positions from the viewpoint to a music indicator;

FIG. 10 illustrates a music selection screen;

FIG. 11 illustrates a music search screen;

FIG. 12 illustrates a switching operation of a music selection screen within the music search screen;

FIG. 13 illustrates how a music search area is detected;

FIG. 14 illustrates how music is selected;

FIG. 15 illustrates how a music indicator is manipulated in an expansion area;

FIG. 16 illustrates how the music selection screen is expanded;

FIG. 17 illustrates a music selection and expansion image within the music search screen;

FIG. 18 illustrates how music is introduced using the music search screen;

FIG. 19 illustrates how music search results are displayed within the music search screen;

FIG. 20 illustrates a structure of a play list;

FIG. 21 is a block diagram illustrating in detail a music providing apparatus in accordance with one embodiment of the present invention;

FIG. 22 illustrates a music search screen;

FIG. 23 illustrates a switching operation of a music selection screen within the music search screen;

FIG. 24 illustrates a music selection and expansion screen within the music search screen;

FIG. 25 illustrates how music is introduced on the music search screen;

FIG. 26 illustrates how music search results are displayed on the music search screen;

FIG. 27 is a flowchart illustrating an image generation process;

FIG. 28 is a flowchart of a first display process;

FIG. 29 is a flowchart a music introduction process;

FIG. 30 is a flowchart illustrating a music selection process;

FIG. 31 is a flowchart illustrating a first music introduction process;

FIG. 32 is a continuation of the flowchart of FIG. 31;

FIG. 33 illustrates a three-dimensional image in accordance with one embodiment of the present invention;

FIGS. 34A and 34B illustrate a music selection process in accordance with one embodiment of the present invention; and

FIGS. 35A and 35B illustrate another music selection process in accordance with one embodiment of the present invention.

### DESCRIPTION OF THE PREFERRED EMBODIMENTS

The embodiments of the present invention are described below with reference to the drawings.

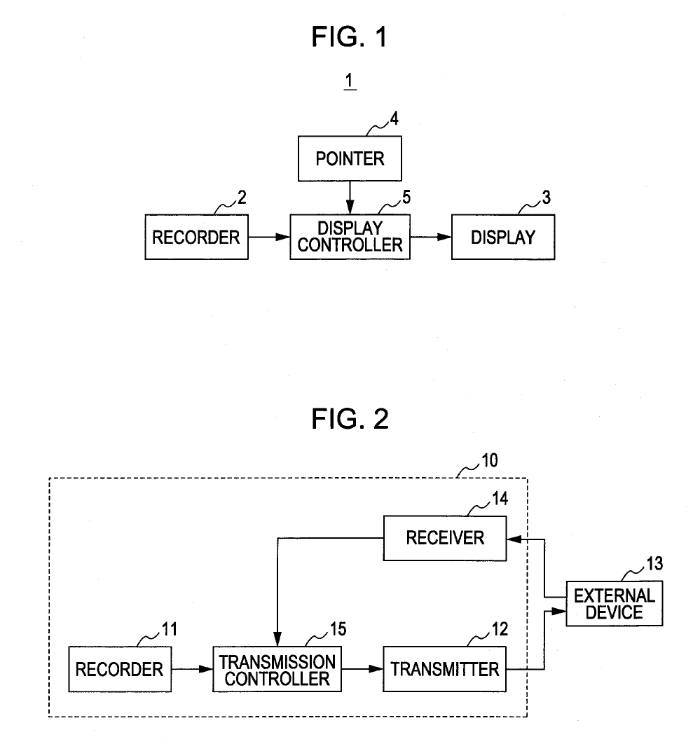

FIG. 1 generally illustrates a display apparatus 1 in accordance with one embodiment of the present invention. A recorder 2 in the display apparatus 1 records a plurality of two-dimensional images that are obtained with a three-dimensional image viewed from different viewpoints, the three-dimensional image having a plurality of content indicators representing contents and arranged in three-dimensional coordinates representing first through third impression values of impression at each content. The first through third impression values are obtained by digitizing three types of impressions of each content. A display 3 in the display apparatus 1 displays the two-dimensional image recorded on the recorder 2. A pointer 4 in the display apparatus 1 points to the viewpoint for modification to view the three-dimensional image. A display controller 5 in the display apparatus 1 reads from the recorder 2 one of two-dimensional images with the three-dimensional image viewed from a predetermined viewpoint. The display controller 5 reads from the recorder 2 another two-dimensional image with the three-dimensional image viewed from another viewpoint in response to an operation input entered to the pointer 4 with the read two-dimensional image being displayed on the display, and displays the other read two-dimensional image on the display 3.

The display apparatus 1 thus constructed prepares a plurality of two-dimensional images generated with the three-dimensional image viewed from the different viewpoints. If an instruction to modify the viewpoint to view the three-dimensional image is issued, the display apparatus 1 selects the two-dimensional image responsive to the modified viewpoint and displays the selected two-dimensional image on the display 3. With this arrangement, process workload involved in switching the two-dimensional images generated with the three-dimensional image viewed from the different viewpoints is substantially reduced. The display apparatus 1 can thus display the two-dimensional images indicating the impression of each content.

FIG. 2 illustrates an image providing apparatus 10 in accordance with one embodiment of the present invention. A recorder 11 in the image providing apparatus 10 records a plurality of two-dimensional images that are obtained with a three-dimensional image viewed from different viewpoints, the three-dimensional image having a plurality of content indicators representing contents and arranged in three-dimensional coordinates representing first through third impression values of impression at each content. The first through third impression values are obtained by digitizing three types of impressions of each content. A transmitter 12 in the image providing apparatus 10 transmits the two-dimensional image recorded on the recorder 11 to an external device 13 displaying two-dimensional images. A receiver 14 in the image providing apparatus 10 receives request information transmitted from the external device 13 requesting that the viewpoint to view the three-dimensional image be modified. A transmission controller 15 in the image providing apparatus 10 reads from the recorder 11 a two-dimensional image generated with the three-dimensional image viewed from a predetermined viewpoint. The transmission controller 15 causes the read two-dimensional image to be transmitted from the transmitter 12 to the external device 13. When the receiver 14 receives the request information from the external device 13 displaying two-dimensional images, the transmission controller 15 reads from the recorder 11 the two-dimensional image that is generated with the three-dimensional image viewed from the modified viewpoint indicated by the request information received via the receiver 14. The transmission controller 15 then causes the read two-dimensional image to be transmitted from the transmitter 12 to the external device 13.

The image providing apparatus 10 thus constructed prepares beforehand a plurality of two-dimensional images generated with the three-dimensional image viewed from the different viewpoints. If an instruction to modify the viewpoint to view the three-dimensional image is issued from the external device 13, the image providing apparatus 10 selects the two-dimensional image responsive to the modified viewpoint from among the prepared two-dimensional images and transmits the selected two-dimensional image to the external device 13. With this arrangement, process workload involved in switching and transmitting the two-dimensional images generated with the three-dimensional image viewed from the different viewpoints is substantially reduced. The image providing apparatus 10 can thus display the two-dimensional images indicating the impression of each content.

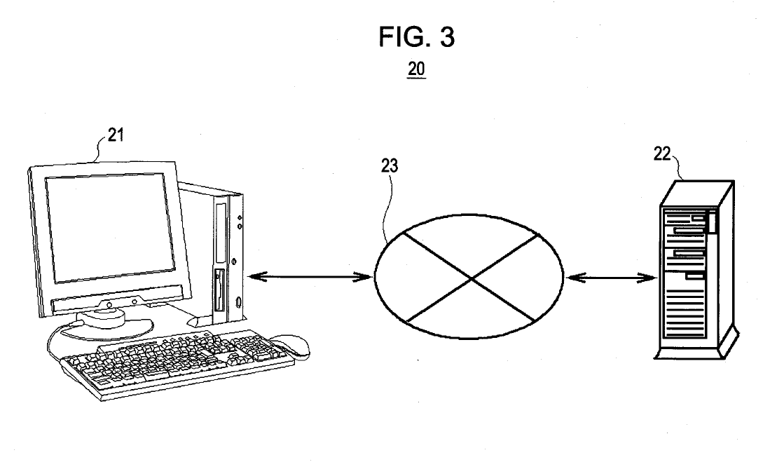

FIG. 3 generally illustrates a music selection system 20 in accordance with one embodiment of the present invention. The music selection system 20 includes a data recording and playing apparatus 21 arranged in a personal computer implementing the display apparatus of one embodiment of the present invention, and a music providing apparatus 22 arranged in a server implementing the image providing apparatus of one embodiment of the present invention. In the music selection system 20, the data recording and playing apparatus 21 operated by a user communicates with the music providing apparatus 22 via a network 23.

The data recording and playing apparatus 21 stores music (song) data read from a compact disk (CD) or retrieved from the music providing apparatus 22. The data recording and playing apparatus 21 allows the user to select desired music data from a plurality of pieces of music data stored therewithin and plays the selected music data for the user. The music providing apparatus 22 stores a numerous pieces of music data. The music providing apparatus 22 allows the user to select desired music data from among the numerous pieces of music data via the data recording and playing apparatus 21 and supplies the selected music data to the data recording and playing apparatus 21.

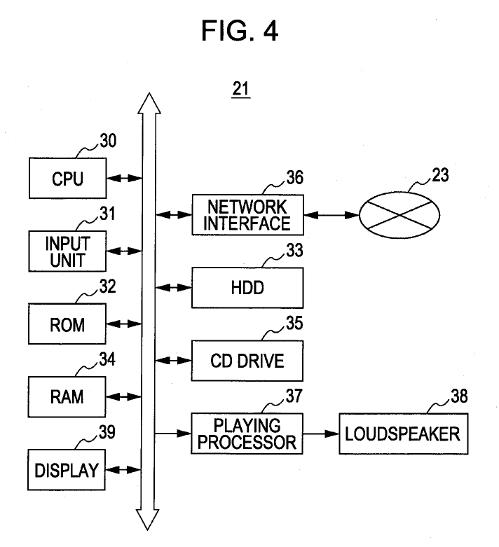

With reference to FIG. 4, a hardware structure of the data recording and playing apparatus 21 is described below on a block by block basis. In response to a variety of commands input on an input unit 31, such as a keyboard and a mouse, by the user, a central processing unit (CPU) 30 in the data recording and playing apparatus 21 reads a variety of programs including a operating system, application programs, and a display program from one of a read-only memory (ROM) 32 and a hard disk drive (HDD) 33, and expands the read programs on a random-access memory (RAM) 34. The CPU 30 generally controls the data recording and playing apparatus 21 in accordance with the variety of programs, while performing a predetermined process and a variety of processes in response to commands input via the input unit 31.

When a record command to record music data is input via the input unit 31 with a CD loaded on the CD drive 35, the CD drive 35 reads the music data from the CD, and supplies the read music data to the hard disk drive 33 for recording. The CD includes, on a data recording surface, a music data recording region and a management data recording region. The music data recording region of the CD records a plurality of pieces of music (song) data. The management data recording region of the CD records management data, called Table of Contents (TOC), for managing the plurality of pieces of music data recorded on the music data recording region. The management data contains play time and play order for individual pieces of music data, and play start position in the music data recording region.

When reading the music data from the music data recording region with the CD drive 35, the CPU 30 also reads the management data from the management data recording region of the CD. The CPU 30 generates management information unique to the CD based on such management data and transmits the generated management information to a disk information providing server (not shown) over the network 23 via the network interface 36. When the disk information providing server returns as disk information a set of music related information for each of the plurality of pieces of music data recorded on the CD, the CPU 30 retrieves the disk information via the network interface 36. The CPU 30 transfers the disk information to the hard disk drive 33 and then records the disk information with the music data recorded from the CD associated therewith.

The music related information contains a variety of information such as a title of a song based on the corresponding music data (hereinafter referred to as a song title), an artist name, a name of genre the song belongs to (hereinafter referred to as genre name), and a title of an album containing the song (hereinafter referred to as album title). The disk information contains, in addition to the music related information of the music data, image data of a jacket photograph of the album containing the song (hereinafter referred to as jacket photograph image data).

Upon receiving a command to retrieve desired music data from the user via the input unit 31, the CPU 30 transmits retrieval request information requesting to retrieve the music data to the music providing apparatus 22 via the network interface 36 and the network 23. When the music providing apparatus 22 transmits the requested music data via the network 23, the CPU 30 receives the music data via the network interface 36 and supplies the received music data to the hard disk drive 33 for storage.

The music providing apparatus 22 records the music related information regarding a numerous pieces of music data and the jacket photograph image data with the music data related thereto. When the data recording and playing apparatus 21 issues a retrieval request requesting the music data, the music providing apparatus 22 delivers, together with the music data, the music related information and the jacket photograph image data as the music related data. When the music data delivered by the music providing apparatus 22 is used, the CPU 30 receives the music related data together with the music data from the music providing apparatus 22 via the network interface 36. The CPU 30 supplies the music related data to the hard disk drive 33, thereby recording the music related data with the music data retrieved from the music providing apparatus 22 associated therewith. The CPU 30 thus retrieves a plurality of pieces of music data from the music providing apparatus 22 over the network 23 and then stores the music data.

The CPU 30 receives from the user via the input unit 31 a play command to play the music data stored on the hard disk drive 33. The CPU 30 reads the music data from the hard disk drive 33 and supplies the read music data to the playing processor 37. The playing processor 37 performs a playing process, such as a decode process, on the music data supplied from the CPU 30, and supplies a resulting music signal to the loudspeaker 38. The CPU 30 causes the loudspeaker 38 to emit a song responsive to the music signal to the user.

The CPU 30 performs the recording process, the retrieval process, and the playing process on the music data. The CPU 30 thus outputs display data as a result of these processes to the display 39. The display 39 may be a liquid-crystal display. The CPU 30 thus displays a display screen responsive to the display data on the display 39. The CPU 30 allows the user to recognize visually a variety of information relating to the recording process, the retrieval process and the playing process performed on the music data.

When the music data is recorded on the hard disk drive 33 in the data recording and playing apparatus 21, the CPU 30 frequency analyses the music data. Based on the analysis results, the CPU 30 digitizes three types of items, such as tempo, tone and age representing the impression of music based on the music data, thereby resulting in first through third impression values. The CPU 30 thus obtains the first through third impression values of all music data stored on the hard disk drive 33.

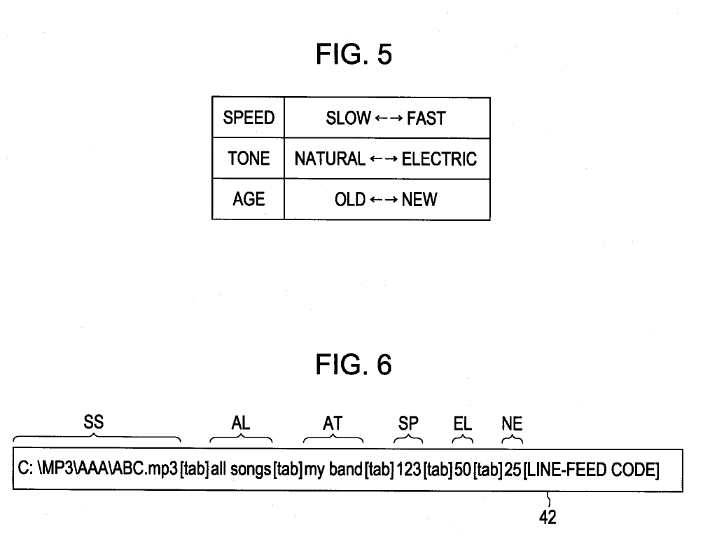

As shown in FIG. 5, the tempo of the three types of items representing the impression of music (song) represents how music is slow to fast. As for the first impression value obtained by digitizing the tempo, the smaller the first impression value, the slower the music is. Conversely, the larger the first impression value, the faster the music is.

The tone of the three types of items represents how the music is felt from natural to electrical. The second impression value is obtained by digitizing the tone. The smaller the second impression value, the more natural the music is felt. Conversely, the larger the second impression value, the more electrical the music is felt.

The age of the three types of items represents how old listeners feel the music, namely, from old to new. The third impression value is obtained by digitizing the age. The smaller the third impression value, the older the listeners are supposed to feel the music. Conversely, the larger the third impression value, the newer the listeners are supposed to feel the music.

Upon obtaining the first through third impression values of each music data, the CPU 30 generates music analysis information 42 of each music data of FIG. 6 based on the first through third impression values and the corresponding music related information. The music analysis information 42 per music data contains music identification information SS permitting the music data to be individually identified, album title AL, artist name AT, a first impression value SP, a second impression value EL and a third impression value NE. The music identification information SS of the music analysis information 42 is one of a path indicating a storage location of the corresponding music data and an identification (ID) unique to the music data contained in the music related information. Upon generating the music analysis information 42, the CPU 30 supplies the generated music analysis information 42 to the hard disk drive 33 for storage.

With power on, the CPU 30 performs the recording process and the retrieval process. The CPU 30 thus stores on the hard disk drive 33 at least one piece of music data and at least one piece of music analysis information 42 corresponding thereto. In response to a power-off command input via the input unit 31 from the user, the CPU 30 transitions each circuit block from the power-on state to a standby state, thereby stopping the operation of each circuit block. The standby state shows that each circuit block stops operating with the display 39 and a power-on lamp extinguished. Power of the apparatus looks turned off. More specifically, in the standby state, most of the circuit blocks are stopped with process workload of the apparatus substantially reduced.

When the standby state is reached in response to the power-off command, the CPU 30 starts an image generation process for generating an image permitting data selection (hereinafter referred to as music selection image). When the image generation process is initiated, the CPU 30 reads all music analysis information 42 from the hard disk drive 33. The CPU 30 sets the first, second and third impression values SP, EL and NE to be three dimensional coordinates, i.e., the first, second and third impression values SP, EL and NE are respectively three mutually perpendicular axes (namely, X axis, Y axis and Z axis) with the intersection thereof as the origin.

More specifically, the CPU 30 sets the first impression value SP of the first, second and third impression values SP, EL and NE to be the X coordinates, the second impression value EL to be the Y coordinates, and the third impression value NE to be the Z coordinates. The CPU 30 generates an three-dimensional image TDI. The three-dimensional image TDI is constructed of dot-like or star-like indicators (hereinafter referred to as music indicators) SI arranged in the three-dimensional coordinates obtained from a plurality of pieces of music analysis information 42.

In the three-dimensional image TDI, the first, second and third impression values SP, EL and NE respectively directly become the three-dimensional coordinates. The X axis of the three mutually perpendicular axes corresponds to the sped of the three types of item of the music impression, the Y axis corresponds to the tone, and the Z axis corresponds to the age. The smaller, the X coordinate of the music indicator SI arranged in the three-dimensional image TDI, the slower the listener feels the music. Conversely, the larger the X coordinate, the faster the listener feels. The smaller the Y coordinate of the music indicator SI arranged in the three-dimensional image TDI, the more natural the listener feels the music. Conversely, the larger the Y coordinate, the more electrical the listener feels the music. The smaller the Z coordinate of the music indicator SI arranged in the three-dimensional image TDI, the older the listener feels the music. Conversely, the larger the Z coordinate, the newer the listener feels the music.

The three-dimensional coordinates representing the first, second and third impression values SP, EL and NE in the three-dimensional image TDI become music impression values accurately representing the impression of music with three types of items. In the three-dimensional image TDI, the music indicator SI is arranged in the three-dimensional coordinates of the first, second and third impression values SP, EL and NE. The user thus intuitively recognizes the music impression by the location position of the music indicator SI.

Since the music indicator SI is arranged in each of the three-dimensional coordinates in the three-dimensional image TDI, music indicators SI having similar music impression are arranged close to each other. The user may intuitively recognize the trend in the impression of a plurality of units of music data recorded on the hard disk drive 33 in the three-dimensional image TDI.

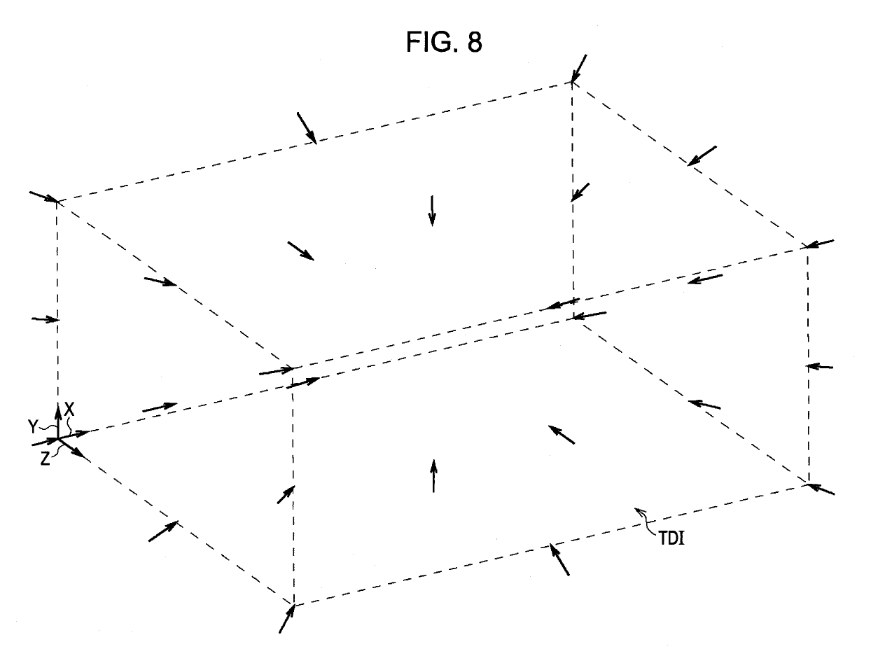

Upon generating the three-dimensional image TDI as shown in FIG. 8, the CPU 30 converts the three-dimensional image TDI into a music selection image composed of a plurality of two-dimensional images. The plurality of two-dimensional images are generated by projecting the three-dimensional image TDI onto two-dimensional planes (two-dimensional planes perpendicular to lines of sight extending from viewpoints as represented by arrow-headed lines) as if viewed from different viewpoints. When converting the three-dimensional image TDI into a plurality of music selection images as if the three-dimensional image TDI is viewed from different viewpoints, the CPU 30 sets an display mode of each music indicator SI so that the perspective of a plurality of music indicators SI is expressed in accordance with the location position of each music indicator SI (distance from the viewpoint) within the three-dimensional image TDI on a per viewpoint basis.

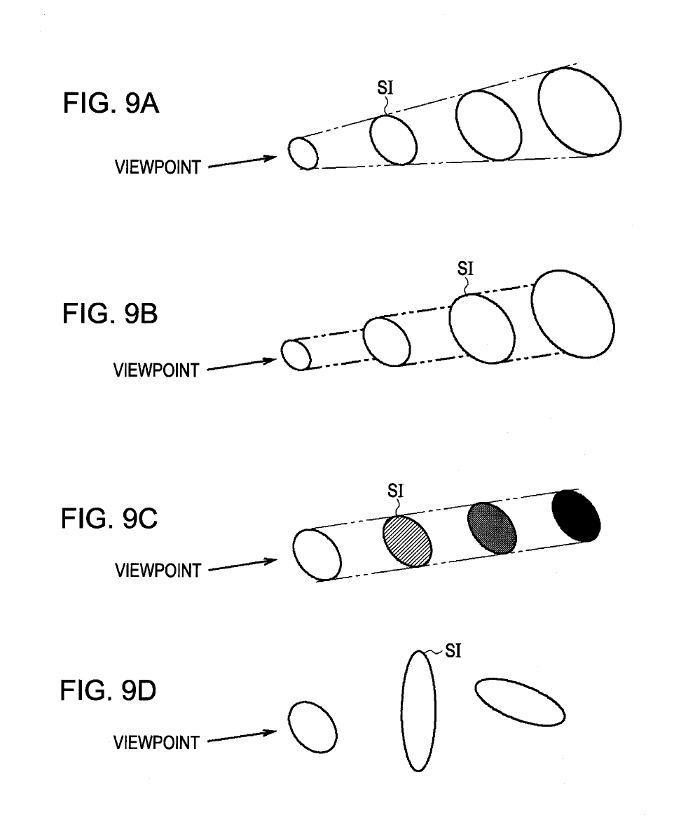

FIGS. 9A-9D illustrate perspective drawing techniques of the music indicator SI. In a perspective drawing technique of FIG. 9A, the music indicator SI becomes gradually larger as it is farther from the viewpoint. Conversely, in another perspective drawing technique, the music indicator SI becomes gradually smaller as it is farther from the viewpoint. In a perspective drawing technique of FIG. 9B, the music indicator SI becomes larger in a stepwise manner at it is farther from the viewpoint. Conversely, in another perspective drawing technique, the music indicator SI becomes smaller in a stepwise manner at it is farther from the viewpoint.

In another perspective drawing technique of FIG. 9C, the transmittance of the music indicator SI becomes gradually lower as it is farther from the viewpoint (the outline of the music indicator SI is drawn to be opaque while the central portion of the music indicator SI is transparent (to see through a view behind), and then the central portion of the music indicator SI becomes more opaque as it is farther from the viewpoint). In another perspective drawing technique, the transmittance of the music indicator SI is set to be lower in a stepwise manner as it is farther from the viewpoint. In a perspective drawing technique of FIG. 9D, the music indicator SI is gradually changed in shape as it is farther from the viewpoint. In yet another perspective drawing technique, the music indicator SI is changed in shape in a stepwise manner as it is farther from the viewpoint. In still another perspective drawing technique, the music indicator SI is changed in color gradually (or stepwise) as it is farther from the viewpoint.

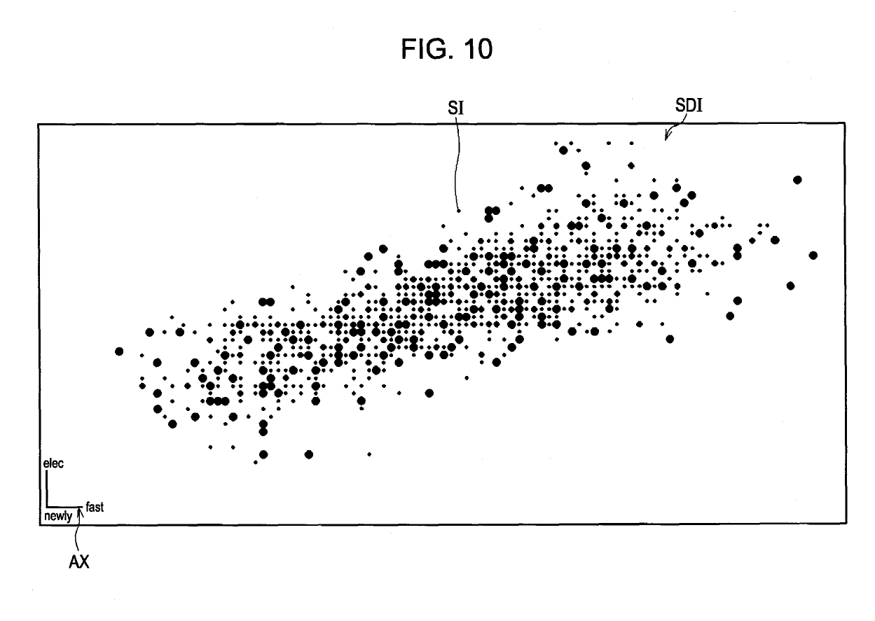

The CPU 30 allows the user to pre-select one of such perspective drawing techniques. When the three-dimensional image TDI is generated as shown in FIG. 10, the CPU 30 sets the display mode of the music indicator SI in order to express the perspective of a plurality of music indicators SI in accordance with the perspective drawing technique selected by the user. The CPU 30 thus generates a music selection image SDI.

When the three-dimensional image TDI is generated, the CPU 30 generates a projection axis image AX composed of a two-dimensional image. The two-dimensional image is obtained by projecting the three-dimensional image TDI onto two-dimensional planes along the three axes from the respective viewpoints. The CPU 30 overlays the projection axis image AX onto the music selection image SDI generated with respect to the same viewpoint according to which the projection axis image AX has been generated.

In the projection axis image AX, the end of the x axis for music impression notification is labeled letters “fast” indicating that music becomes faster as the music indicator SI is located farther from the origin along the x axis. Also in the projection axis image AX, the end of the Y axis is labeled letters “elec” indicating that music becomes more electric as the music indicator SI is located farther from the origin along the Y axis. Further in the projection axis image AX, the end of the Z axis is labeled letters “newly” indicating that music becomes newer as the music indicator SI is located farther from the original along the Z axis.

The music selection image SDI is expressed by the projection axis image AX (namely, the three axes and the letters) and the perspective of a plurality of music indicators SI. The music selection image SDI can allow the user to recognize intuitively the impression of music corresponding to the plurality of music indicators SI. More specifically, in the music selection image SDI, music becomes slower as the music indicator SI is located closer to the origin along the X axis of the projection axis image AX. Conversely, music becomes faster as the music indicator SI is located farther from the original along the X axis.

In the music selection image SDI, music becomes more natural as the music indicator SI is located closer to the origin along the Y axis of the projection axis image AX. Conversely, music becomes more electric as the music indicator SI is located farther from the origin along the Y axis. In the music selection image SDI, music becomes older as the music indicator SI is located closer to the origin along the Z axis of the projection axis image AX. Conversely, music becomes newer as the music indicator SI is located farther from the origin along the Z axis.

The CPU 30 supplies a plurality of music selection images SDI with the projection axis image AX overlaid thereon to the hard disk drive 33 as music selection image data for storage.

In the music selection image SDI, the X axis extends from the origin to the right side, the Y axis extends from the origin to the upper side, and the Z axis extends from the origin to the front side. The viewpoints in the conversion of the three-dimensional image TDI to the music selection image SDI may be set as if viewing the three-dimensional image TDI from the front side, the rear side, the right side, the left side, the (right) upper side and the (right) lower side. Furthermore, the viewpoints in the conversion of the three-dimensional image TDI to the music selection image SDI may be set as if viewing the three-dimensional image TDI from the right-frontward side, the left-frontward side, the right-rearward side and the left-rearward side.

Furthermore, the viewpoints in the conversion of the three-dimensional image TDI to the music selection image SDI may be set as if viewing the three-dimensional image TDI from the upper-slanted frontward side, the lower-slanted frontward side, the upper-slanted rearward side, the lower-slanted rearward side, the upper-slanted rightward side, the lower-slanted rightward side, the upper-slanted leftward side and the lower-slanted leftward side. Furthermore, the viewpoints in the conversion of the three-dimensional image TDI to the music selection image SDI may be set as if viewing the three-dimensional image TDI from the upper-slanted right-frontward side, the lower-slanted right-frontward side, the upper-slanted left-frontward side, the lower-slanted left-frontward, the upper-slanted right-rearward side, the lower-slanted right-rearward side, the upper-slanted left-rearward side and the lower-slanted left-rearward side.

The CPU 30 sets as a reference viewpoint a viewpoint positioned in an imaginary line passing through the center of the three-dimensional image TDI and extending in parallel with the Z axis (for example, a viewpoint positioned on the front side) from among a plurality of viewpoints. The CPU 30 stores, as viewpoint position definition information, an angle of rotation of the reference viewpoint with about each of the X axis and the Y axis out of the three axes of the three-dimensional image TDI (two types of angle rotation set to zero in this case). The viewpoint position definition information defines the location position of the reference viewpoint.

The CPU 30 also stores as the viewpoint position definition information the angles of rotation of a plurality of viewpoints except the reference viewpoint with respect to the X axis and the Y axis referenced to the angles of rotation of the X and Y axes of the reference viewpoint (the angles of rotation indicating how many degrees the viewpoints are rotated about the X and Y axes). The viewpoint position definition information thus defines the location positions of the plurality of viewpoints. When the CPU 30 stores a plurality of music selection image data elements on the hard disk drive 33, the plurality of music selection image data elements are associated with respective viewpoint position definition information elements.

The location positions of the plurality of viewpoints are defined the angle of rotations about each of the X and Y axes out of the three axes. Let represent the three-dimensional coordinates (x,y,z) in which each music indicator SI within the three-dimensional image TDI is arranged on a per viewpoint basis, θ1 represent the angle of rotation of the viewpoint about the X axis and the θ2 represent the angle of rotation of the viewpoint about the Y axis, and the CPU 30 determines the X coordinate of the music indicator SI in the music selection image SDI composed of the two-dimensional image in accordance with equation (1):

X=x cos(θ2)−z sin(θ2) (1)

The CPU 30 also determines the Y coordinate of the music indicator SI in the music selection image SDI composed of the two-dimensional image in accordance with equation (2):

Y=(x sin(θ2)+z sin(2))sin(θ1)−y cos(θ1) (2)

The CPU 30 thus generates a plurality of music selection images SDI from the three-dimensional image TDI using different viewpoints.

During the standby state, the CPU 30 ends the image generation process after generating and storing the plurality of music selection images SDI as the music selection image data on the hard disk drive 33 and. The CPU 30 is transitioned to the power-off state (with power switched off), thereby completely stopping operating the playing apparatus 21. Even if a plurality of music selection image data elements are stored on the hard disk drive 33, the CPU 30 determines whether music data is newly stored on the hard disk drive 33 during the power-on state each time the data recording and playing apparatus 21 is transitioned from the power-on state to the standby state.

If new music data is stored on the hard disk drive 33 during the power-on state, the CPU 30 generates a plurality of music selection images SDI together with the three-dimensional image TDI using the new music data. The CPU 30 updates the plurality of units of music selection image data already recorded on the hard disk drive 33 to a plurality of units of new music selection image data.

Without the need for transitioning from the power-on state to the standby state, the CPU 30 performs the image generation process in response to the input of an execution command of the image generation process from the user via the input unit 31 during the power-on state. If new music data is recorded onto the hard disk drive 33, the CPU 30 starts the image generation process at any timing indicated by the user without the need for waiting for the transition from the power-on state to the standby state. The plurality of units of music selection image data are thus updated.

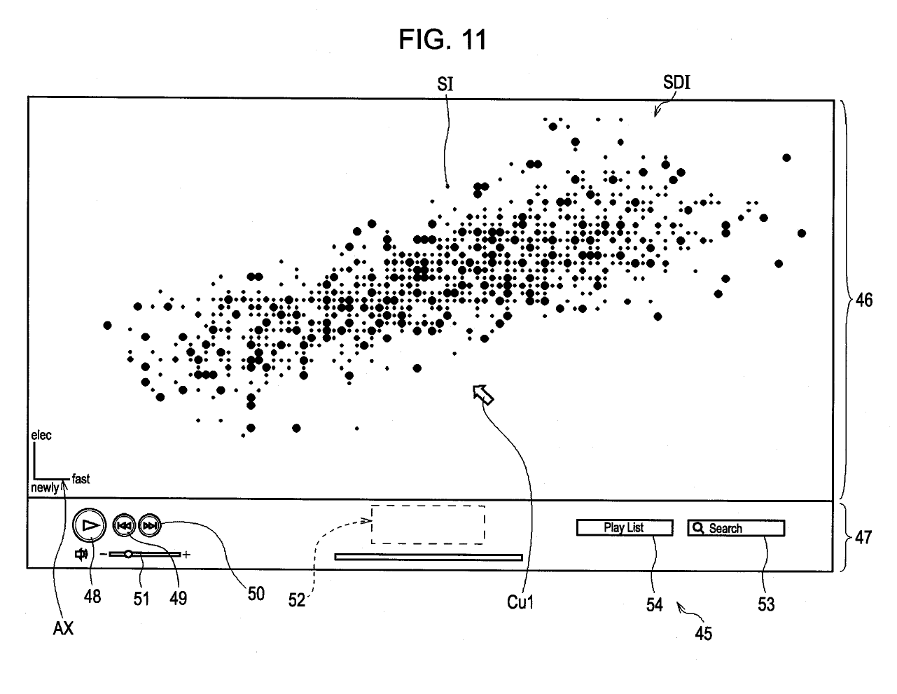

If a music selection request is input via the input unit 31 by the user with the plurality of units of music selection image data stored on the hard disk drive 33, the CPU 30 reads from the hard disk drive 33 the music selection image data generated using the reference viewpoint. The CPU 30 also reads from the hard disk drive 33 music search screen data pre-recorded on the hard disk drive 33. The CPU 30 combines the music search screen data with the music selection image data and supplies the music search screen data with the music selection image data combined therewith to the display 39. The CPU 30 thus displays on the display 39 a music search screen 45 of FIG. 11 based on the music search screen data.

The music search screen 45 includes a music selection partition 46 and an operation partition 47. The music selection image SDI and the projection axis image AX overlaid on the music selection image SDI are displayed on the music selection partition 46. An indicator (hereinafter referred to as a cursor) Cu1 for pointing to the music indicator SI is also overlaid on the music selection image SDI in the music selection partition 46.

The operation partition 47 of the music search screen 45 includes a play start button 48 for controlling playing of the music data selected as the music indicator SI on the music selection image SDI, a song backward button 49, a song forward button 50 and a play position indicator 51 for notifying of a play position along play time axis of the music data. The operation partition 47 also includes a play music notifier section 52 that notifies the user of music based on the music data currently being played. The play music notifier section 52 shows at least part of the music related information for the music data currently being played (for example, music title, album title, and an artist name).

The operation partition 47 further includes a search condition input section 53 that allows the user to input a search condition for searching music (such as artist name, album title, and genre name). The operation partition 47 also includes a list generation button 54 for generating a play list defining play order of a plurality of songs.

When the music search screen 45 is displayed on the display 39, the CPU 30 uses up, down, left and right arrow keys arranged on a keyboard to modify the viewpoint to view the three-dimensional image TDI and to select the modified viewpoint. For example, the music selection image SDI generated with the three-dimensional image TDI viewed from the reference viewpoint (namely, the front viewpoint) may be displayed within the music search screen 45. If the user presses the up arrow key once to modify the viewpoint, an upper-slanted frontward viewpoint rotated by one notch from the reference viewpoint in the upper direction designated by the up arrow key (more specifically, in a direction in which space containing the three-dimensional image TDI of FIG. 8 is rotated from up to down) is selected as a modified viewpoint.

If the user presses the down arrow key once to modify the viewpoint, an lower-slanted frontward viewpoint rotated by one notch from the reference viewpoint in the lower direction designated by the down arrow key (more specifically, in a direction in which space containing the three-dimensional image TDI of FIG. 8 is rotated from down to up) is selected as a modified viewpoint. If the user presses the right arrow key once to modify the viewpoint, a right frontward viewpoint rotated by one notch from the reference viewpoint in the right direction designated by the right arrow key (more specifically, in a direction in which space containing the three-dimensional image TDI of FIG. 8 is rotated from right to left) is selected as a modified viewpoint.

If the user presses the left arrow key once to modify the viewpoint, a left frontward viewpoint rotated by one notch from the reference viewpoint in the left direction designated by the left arrow key (more specifically, in a direction in which space containing the three-dimensional image TDI of FIG. 8 is rotated from left to right) is selected as a modified viewpoint. Each time the user presses the arrow key, the CPU 30 allows the user to shift to a viewpoint, next to the current viewpoint, to view the three-dimensional image TDI.

A viewpoint modification command to modify the viewpoint to view the three-dimensional image TDI may be input by the user via the input unit 31 (keyboard) with the music search screen 45 displayed on the display 39. The CPU 30 detects the viewpoint position definition information of the modified viewpoint selected by the user, based on the viewpoint position definition information corresponding to the music selection image SDI displayed on the music search screen 45 and the arrow key pressed by the user. The CPU 30 reads from the hard disk drive 33 the music selection image data corresponding to the viewpoint position definition information of the modified viewpoint (namely, the music selection image data of the music selection image SDI generated with the three-dimensional image TDI viewed from the viewpoint selected by the user).

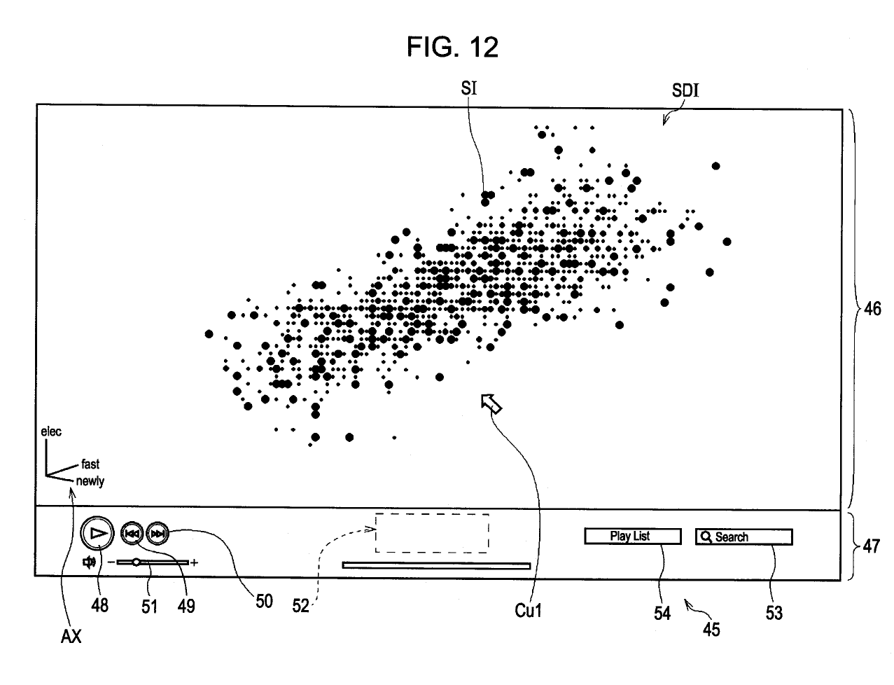

The CPU 30 combines the music selection image data corresponding to the modified viewpoint with the music search screen data and then supplies to the display 39 the music search screen data with the music selection image data combined therewith. The CPU 30 displays on the display 39 the music search screen 45 of FIG. 12 based on the music selection image data. The CPU 30 modifies the music selection image SDI displayed in the music selection partition 46 of the music search screen 45 to the music selection image SDI generated with the three-dimensional image TDI viewed from the viewpoint selected by the user.

When the three-dimensional image TDI is viewed from one viewpoint, a back music indicator SI may be hidden in the shadow of a plurality of front music indicators SI. The back music indicator SI cannot be displayed in the music selection image SDI generated with reference to that viewpoint. In such a case, the music selection images SDI generated with different viewpoints are appropriately switched within the music selection partition 46 of the music search screen 45. The user can thus view any music indicator SI. Even if the music selection image SDI displayed on the music selection partition 46 of the music search screen 45 is switched, the user can easily recognize the impression of the music indicated by individual music indicator SI with the projection axis image AX overlaid on the music selection image SDI.

When a movement command of the cursor Cu1 is input via the input unit 31 (such as a mouse) by the user with the music search screen 45 displayed on the display 39, the CPU 30 moves the cursor Cu1 on the music selection partition 46 (namely, on the music selection image SDI) and the operation partition 47 in response to the movement command. When the user clicks on the left button of the mouse twice consecutively with the cursor Cu1 placed on the music selection image SDI (i.e., in a double-click operation), the CPU 30 allows the end of the cursor Cu1 pointing to one position to be selected as a selected position on the music selection image SDI.

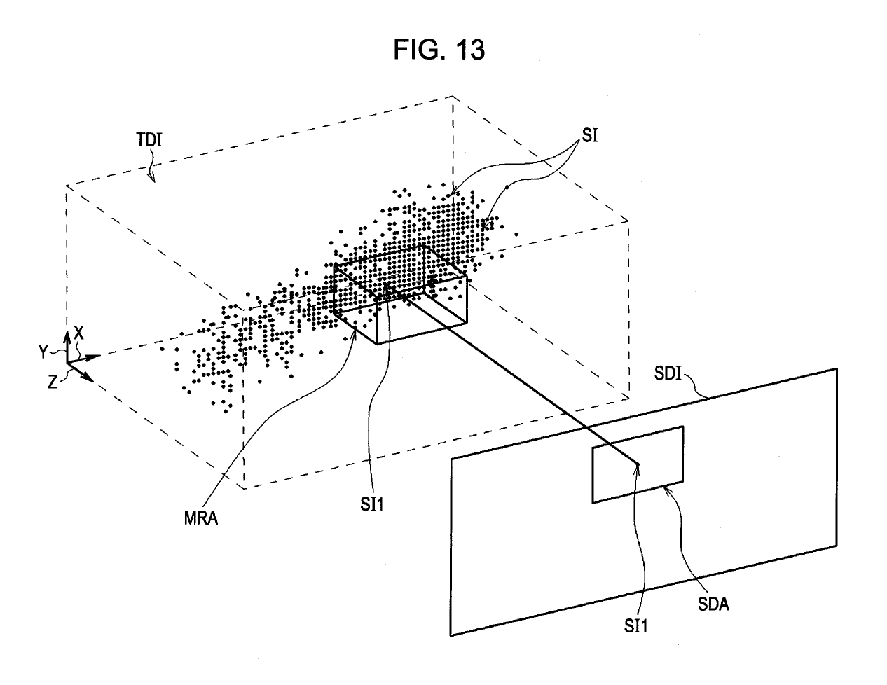

When the user selects any position on the music selection image SDI using the mouse, the CPU 30 detects two-dimensional coordinates at the selected position. As shown in FIG. 13, the CPU 30 detects as an expansion target portion SDA a predetermined portion (smaller in size than the music selection image SDI) centered on the position selected by the user (in the two-dimensional coordinates) within the music selection image SDI displayed on the music selection partition 46 of the music search screen 45.

Based on the two-dimensional coordinates at the selected position in the expansion target portion SDA and the two-dimensional coordinates of a plurality of music indicators SI, the CPU 30 detects the music indicator SI closest to the selected position (shortest in range to the selected position). The CPU 30 sets the detected music indicator SI as a selected music indicator SI1 indicating music selected as a position by the user in accordance with the preferred impression of the user on the music selection image SDI (hereinafter referred to as selected music). More specifically, the CPU 30 converts the two-dimensional coordinates at the selected music indicator SI1 detected within the expansion target portion SDA back to three-dimensional coordinates within the three-dimensional image TDI through calculation reversal to equations (1) and (2).

The CPU 30 detects a predetermined space region MRA for music search centered on the three-dimensional coordinates at the selected music indicator SI1. The predetermined space region MRA is a three-dimensional space region substantially smaller than the three-dimensional image TDI and hereinafter referred to as music search region. Based on the three-dimensional coordinates contained in the music analysis information 42, the CPU 30 detects all music indicators SI located within the music search region MRA other than the selected music indicator SI1.

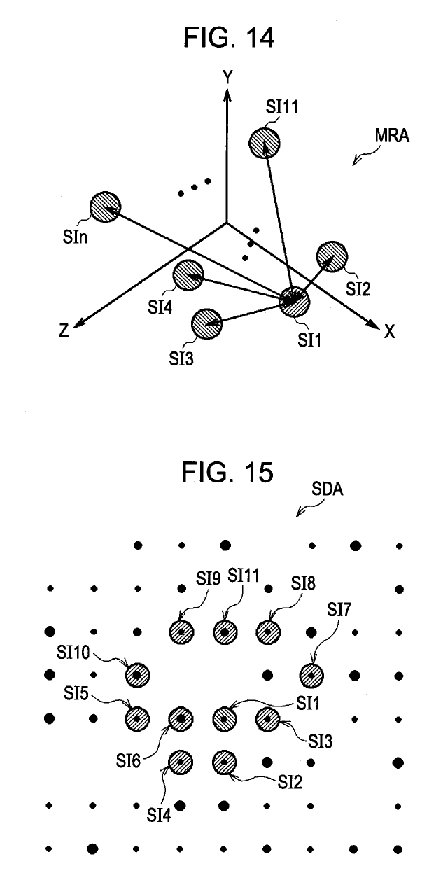

As shown in FIG. 14, the CPU 30 determines a spatial distance between the three-dimensional coordinates of the selected music indicator SI1 and the three-dimensional coordinates of each of the music indicators SI2 through SIn within the music search region MRA and compares the resulting distances. The CPU 30 then selects music indicators SI2 through SI11 of standard selection number (for example, 10) in the order from music indicators SI2 through SI11 according to the order of near to far distance from the selected music indicator SI1. The CPU 30 sets a plurality of music indicators SI2 through SI11 as music that is highly likely to be selected by the user in accordance with the impression preferred by the user (hereinafter referred to as candidate music (song)).

As shown in FIG. 15, the CPU 30 sets the selected music indicator SI1 in a display mode (for example, in a different display color) different from the other music display indicators SI2 through SIn within the expansion target portion SDA of the music selection image SDI. The CPU 30 converts the three-dimensional coordinates of the candidate music display indicators SI2 through SI11 into the two-dimensional coordinates in accordance with the above-described equations (1) and (2). In this way, the CPU 30 determines the plurality of candidate music display indicators SI2 through SI11 within the expansion target portion SDA according to the two-dimensional coordinates thereof. The CPU 30 also sets the candidate music display indicators SI2 through SI11 within the expansion target portion SDA to be in a display mode different from the selected music indicator SI1 and a plurality of other music display indicators SIn (for example, in a different display color).

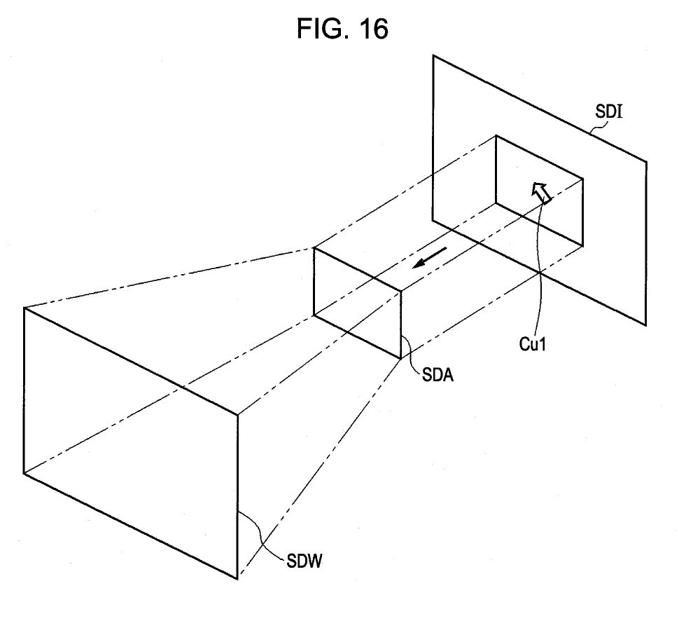

With this state, the CPU 30 extracts the expansion target portion SDA from the music selection image SDI as shown in FIG. 16. The CPU 30 performs an expansion process on the expansion target portion SDA in accordance with a predetermined expansion rate, thereby generating a music selection expansion image SDW equal in size to the original music selection image SDI. The CPU 30 combines the data of the music selection expansion image SDW with the music search screen data, thereby outputting the combined data to the display 39.

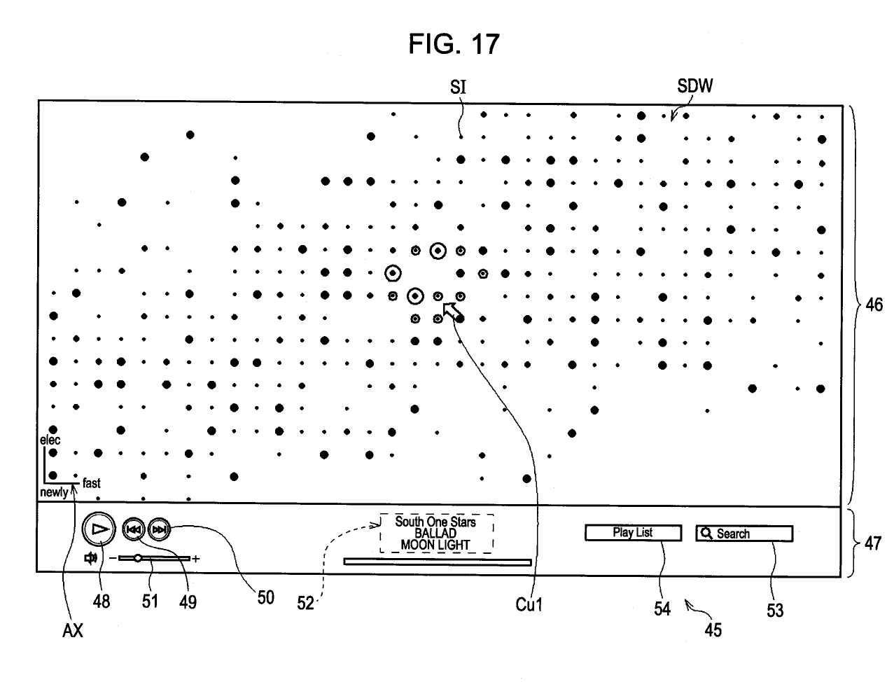

As shown in FIG. 17, the CPU 30 displays the music selection expansion image SDW within the music selection partition 46 of the music search screen 45 displayed on the display 39 with the center position of the music selection partition 46 in alignment with the center position of the music selection expansion image SDW (namely, the position selected by the user). On the music selection expansion image SDW, the CPU 30 thus displays properly the music indicator SI1 selected by the user and the plurality of candidate music display indicators SI2 through SI11 becoming selected candidates in response to the selection by the user in respectively different display modes.

The CPU 30 also overlays the corresponding projection axis image AX on the music selection expansion image SDW in the music search screen 45. By the projection axis image AX in the music selection expansion image SDW, the CPU 30 also displays the impressions of the selected song and the plurality of candidate songs indicated by the selected music indicator SI1 and the plurality of candidate music display indicators SI2 through SI11.

In addition, the CPU 30 detects the selected music indicator SI1 and selects the plurality of candidate music display indicators SI2 through SI11. The CPU 30 reads the music data corresponding to the selected music indicator SI1 from the hard disk drive 33, and then plays the music data through the playing processor 37 and the loudspeaker 38. Along with the playing operation, the CPU 30 reads successively from the hard disk drive 33 the music data of the candidate music display indicator SI2 closest to the selected music indicator SI1 and the music data of the farther candidate music display indicators SI3 through SI11, and then plays the read music data through the playing processor 37 and the loudspeaker 38. The CPU 30 thus allows the user to listen actually to the selected song and the plurality of candidate songs indicated by the selected music indicator SI1 and the plurality of candidate music display indicators SI2 through SI11, and to verify whether the music matches (is close to) the user's preference.

The CPU 30 plays successively characteristic portions, such as climax portions, of the selected song and the plurality of candidate songs in the music data corresponding to the selected music indicator SI1 and the plurality of candidate music display indicators SI2 through SI11. Within a relatively short period of time, the CPU 30 allows the user to finish verifying whether the selected song and the plurality of candidate songs match the user's preference.

The CPU 30 displays in a play display mode (for example, in a particular display color selected for play only) one of the selected music indicator SI1 and the plurality of candidate music display indicators SI2 through SI11 currently being played. On the play music notifier section 52 of the music search screen 45, the CPU 30 displays the music related information corresponding to the music data currently being played. In this way, the CPU 30 visually displays to the user the impression of the selected music and the candidate music based on the music data currently being played while teaching the user the song name.

The user may click on the play start button 48 with the cursor Cu1 on the operation partition 47 of the music search screen 45 using the input unit 31 (such as a mouse). In response, a one-song play command may be input. The CPU 30 re-start playing the music data, being played at that moment, with the start point thereof. Even if the characteristic portions of the plurality of units of music data are automatically and consecutively played, the CPU 30 switches from partial playing of the music data to general playing. The CPU 30 allows the user to recognize the general impression of the selected music and the candidate music.

The user may click on the song backward button 49 with the cursor Cu1 using the input unit 31 (such as a mouse) while the characteristic portions or the entire portions of the music data corresponding to the candidate music display indicators SI2 through SI11 are being played. In response, a song backward command may be input. The CPU 30 stops playing the characteristic portion or the entire portion of the music data at that moment and plays the characteristic portion of the music data played immediately prior to the current song. Even if the user requests during the playing of the candidate music that one of the selected song and the candidate songs immediately prior to the current song be compared with the current song, the CPU 30 quickly responds to the request by comparing the impressions of the songs.

If the song backward command is input during the playing of the characteristic portion or the entire portion of the music data corresponding to the selected music indicator SI1, the CPU 30 re-starts playing the characteristic portion of the music data from the start of the song. When the music data corresponding to the selected music indicator SI1 is played, the CPU 30 plays repeatedly the music data and allows the user to recognize reliably the impression of the selected music.

The user may click on the song forward button 50 with reference to the cursor Cu1 using the input unit 31 while the characteristic portions or the entire portions of the music data corresponding to one of the selected music indicator SI1 and the plurality of candidate music display indicators SI2 through SI11 are being played. In response, a song forward command may be input. The CPU 30 stops playing the characteristic portion or the entire portion of the music data at that moment and plays the characteristic portion of the music data to be played immediately subsequent to the current song. If the user recognizes the impression of one of the selected song and the candidate songs soon after the start of playing, the CPU 30 avoids continuously playing subsequent part of the music data.

The user may perform a selection operation with the cursor Cu1 overlaid on the projection axis image AX with the music selection expansion image SDW displayed on the music selection partition 46 of the music search screen 45. In response, the CPU 30 causes the original music selection image SDI prior to the extraction of the music selection expansion image SDW to be displayed on the music selection partition 46 of the music search screen 45. Even if the music selection image SDI is switched to the music selection expansion image SDW in response to a request from the user, the CPU 30 can easily switch to the original state.

The cursor Cu1 may be moved on the music selection image SDI (or music selection expansion image SDW) in response to the input unit 31 (for example, a mouse) operated by the user. In response to the end of the operation of the input unit 31 by the user, the CPU 30 waits on standby until the cursor Cu1 stops moving. When the cursor Cu1 stops moving on the music selection image SDI (or the music selection expansion image SDW), the CPU 30 detects two-dimensional coordinates of a position pointed to by the end of the cursor Cu1 (hereinafter referred to as end point position). The CPU 30 starts time counting with an internal counter at the moment the cursor Cu1 stops moving.

With the timer, the CPU 30 time counts for a predetermined period of time (hereinafter referred to as introduction waiting time of several seconds) set as waiting time before the start of introduction of music to the user. If the user re-starts moving the cursor Cu1 on the music selection image SDI (or the music selection expansion image SDW) using the input unit 31 before the introduction waiting time has elapsed, the CPU 30 stops time counting and resets the timer. If the introduction waiting time has elapsed on the timer with the cursor Cu1 remaining stationary, the CPU 30 detects a music indicator SI closest to the end point position at the end of the introduction waiting time on the music selection image SDI (or the music selection expansion image SDW) based on the two-dimensional coordinates of the end point position and the two-dimensional coordinates of the plurality of music indicators SI.

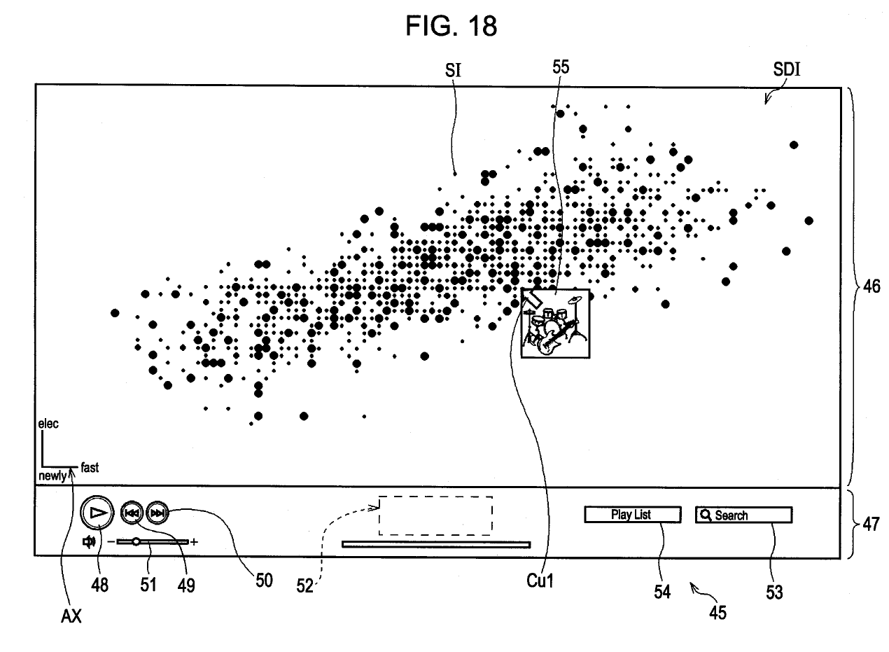

Upon detecting the music indicator SI closest to the end point position, the CPU 30 converts the two-dimensional coordinates of the detected music indicator SI into three-dimensional coordinates within the three-dimensional image TDI in accordance with calculation operations reversal to the above-described equations (1) and (2). Based on the three-dimensional coordinates and the music analysis information 42, the CPU 30 determines the music data corresponding to the music indicator SI closest to the end point position, reads from the hard disk drive 33 the jacket photograph image data corresponding to the determined music data and supplies the read jacket photograph image data to the display 39. As shown in FIG. 18, the CPU 30 displays on the display 39 a rectangular jacket photograph image 55 based on the jacket photograph image data with one corner of the jacket photograph image 55 overlaid on the end point position of the cursor Cu1 on the music search screen 45.

Each time the introduction waiting time has elapsed with the cursor Cu1 remaining stationary on the music selection image SDI (or the music selection expansion image SDW), the CPU 30 displays the jacket photograph image 55 corresponding to the music indicator SI closest to the end point position of the cursor Cu1 remaining stationary. The CPU 30 thus introduces the song of the music indicator SI pointed to by the end of the cursor Cu1 on the music selection image SDI (or the music selection expansion image SDW) using the jacket photograph image 55.

The jacket photograph image 55, if overlaid on the music selection image SDI (or the music selection expansion image SDW) in the music search screen 45, can hide one or a plurality of music indicators SI depending on the position thereof. Even after the start of displaying the jacket photograph image 55, the CPU 30 quits displaying the jacket photograph image 55 when the cursor Cu1 re-start moving (with the jacket photograph image 55 disappearing).

The cursor Cu1 remains stationary with the jacket photograph image 55 displaying. If a predetermined period of time (hereinafter referred to as display time lasting several seconds) has elapsed since the beginning of the displaying of the jacket photograph image 55, the CPU 30 ends displaying the jacket photograph image 55. The CPU 30 prevents the jacket photograph image 55 from presenting difficulty in the user operation in which the user recognizes the geometry of the plurality of music indicators SI on the music selection image SDI (or the music selection expansion image SDW) and the user selects a position using the cursor Cu1.

With the jacket photograph image 55 overlaid on the music selection image SDI (or the music selection expansion image SDW) in the music search screen 45, the CPU 30 determines whether another music data element different from the music data corresponding to the jacket photograph image 55 (namely, corresponding to the music indicator SI closest to the end point position) is being played. If it is determined that the other music data is being played with the jacket photograph image 55 overlaid on the music selection image SDI (or the music selection expansion image SDW), the CPU 30 continuously plays the other data.

If it is determined that the other data is not being played with the jacket photograph image 55 overlaid on the music selection image SDI (or the music selection expansion image SDW), the CPU 30 plays the characteristic portion of the music data corresponding to the jacket photograph image 55. The CPU 30 displays on the play music notifier section 52 of the music search screen 45 the music related information corresponding to the music data currently being played. In this way, the CPU 30 allows the user to listen actually to the song indicated by the music indicator SI pointed to by the cursor Cu1, thereby causing the user to verify the impression of the song and teaching the user the song name.

The user may click on the play start button 48 using the input unit 31 in accordance with the guidance of the cursor Cu1 on the operation partition 47 in the music search screen 45. In response, a one-song play command may be input. The CPU 30 re-start playing the music data being played at that moment from the beginning of the song. The CPU 30 allows the user to recognize the impression of the entire music indicated by the music indicator SI in accordance with the cursor Cu1.

The user may operate the input unit 31 to input a search command with search conditions entered in a search condition input section 53 in the operation partition 47 of the music search screen 45. The CPU 30 searches for one or a plurality of music data elements satisfying the search conditions input by the user, based on the search conditions and the content of the plurality of pieces of music related information. Based on the music analysis information 42 of one or the plurality of music data elements hit (namely, three-dimensional coordinates), the CPU 30 calculates two-dimensional coordinates of the plurality of music indicators SI corresponding to one or the plurality of music data elements hit.

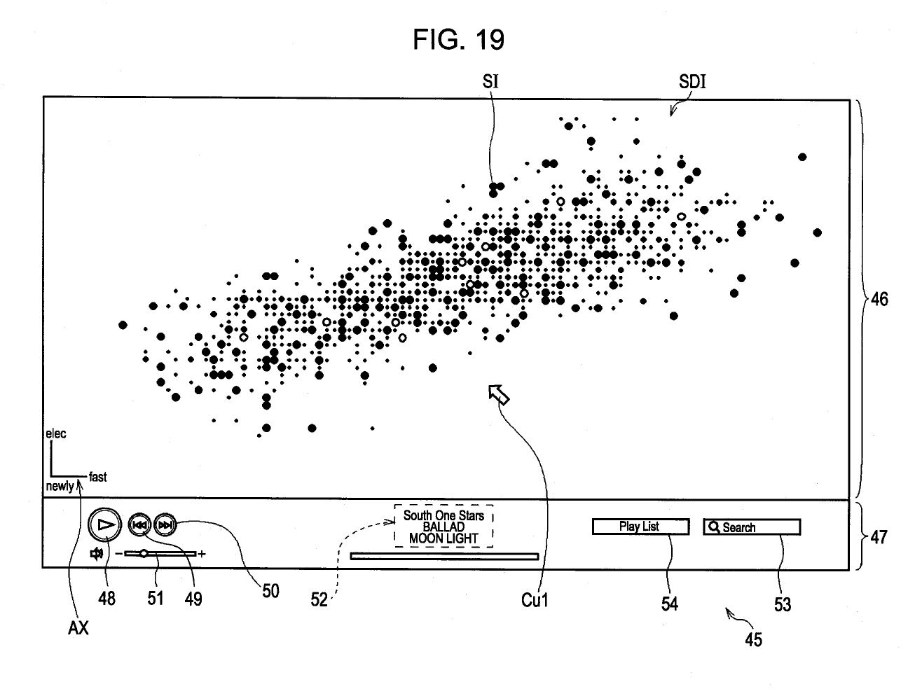

As shown in FIG. 19, the CPU 30 determines one or the plurality of music indicators SI corresponding to one or the plurality of music data elements hit within the music selection image SDI in the music search screen 45 and displays the one or the plurality of music indicators SI determined in a display mode (for example, in a display color) different from the other music indicators SI. The CPU 30 displays easily and reliably to the user the impression of the one or the plurality of songs of an artist, album, and genre specified as the search conditions by the user.

Even when the search results are displayed in the music selection image SDI, the CPU 30 can switch to another music selection image SDI generated based on a different viewpoint. The CPU 30 allows the user to recognize easily the estimated number songs having the impression close to the impression of the song searched.

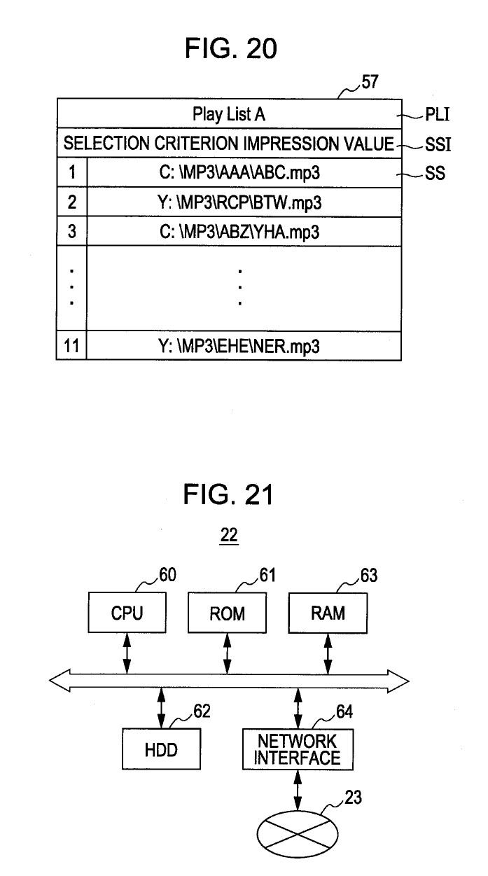

For example, the selected music indicator SI1 may be detected within the music selection expansion image SDW of the music search screen 45, and a plurality of candidate music display indicators SI2 through SI11 may be selected. The user may click on the list generation button 54 using the input unit 31 with reference to the cursor Cu1. In response, a play list generation command may be input. The CPU 30 generates a play list 57 of FIG. 20 listing a plurality of songs corresponding to the selected music indicator SI1 and the plurality of candidate music display indicators SI2 through SI11. The CPU 30 issues identification information unique to the play list 57 (hereinafter referred to as play list identification PLI). The PLI is attached to the play list 57.

The CPU 30 registers in the play list 57 the three-dimensional coordinates of the selected music indicator SI as a selection criterion impression value SSI. The CPU 30 further registers a plurality of units of music data corresponding to the selected music indicator SI1 and the plurality of candidate music display indicators SI2 through SI11 as music identification information SS contained in the music analysis information 42 of the plurality of units of music data.

The CPU 30 lists in the play list 57 the plurality of pieces of music identification information SS in the order of the music data corresponding to the selected music indicator SI1 to the music data corresponding to the farther located candidate music display indicators SI2 through SI11. The CPU 30 thus defines the play order of the plurality of units of music data corresponding to the selected music indicator SI1 and the plurality of candidate music display indicators SI2 through SI11 by the arrangement order of the plurality of music identification information elements SS (i.e., the CPU 30 plays the music data of the selected music indicator SI1 first, and then plays the plurality of units of music data corresponding to the candidate music display indicators SI2 through SI11). Upon generating the play list 57, the CPU 30 records the play list 57 as play list data on the hard disk drive 33.

When the play list 57 is generated, the CPU 30 allows the user to attach to the play list 57 any list name the user can easily identify. The CPU 30 also records on the hard disk drive 33 list management information mapping the list name to the list identification information PLI. During playing of the music data, the user may designate the list name via the input unit 31 and input a play command to play the music data. In response, the CPU 30 determines the play list 57 having the designated list name using the list management information.

The CPU 30 reads from the hard disk drive 33 the determined play list 57 as the play list data. In accordance with the play list 57, the CPU 30 reads from the hard disk drive 33 the plurality of units of music data successively in order and plays the read music data through the playing processor 37 and the loudspeaker 38. The CPU 30 thus allows the user to listen successively to the selected song and the plurality of candidate songs responsive to the plurality of units of music data.

A hardware structure of a music providing apparatus 22 is described in detail below with reference to a functional block diagram of FIG. 21. A central processing unit (CPU) 60 in the music providing apparatus 22 reads a variety of programs including a operating system, application programs, and an image providing program from one of a read-only memory (ROM) 61 and a hard disk drive 62, and expands the read programs on a RAM 63. The CPU 60 generally controls the music providing apparatus 22 in accordance with the variety of programs, while performing a variety of processes.

The CPU 60 records a large number of units of music data on the hard disk drive 62. The CPU 60 also records music related information and jacket photograph image data in association with the large number of units of music data.

When the large number of units of music data are stored on the hard disk drive 62, the CPU 60 reads all the music data from the hard disk drive 62 and frequency analyzes the music data. Based on the frequency analysis results, the CPU 60 digitizes three types of items such as tempo, tone and age representing the impress of each song of the music data, thereby resulting in first through third impression values SP, EL and NE.

The CPU 60 obtains the first through third impression values SP, EL and NE of all music data recorded on the hard disk drive 62. The CPU 60 generates the music analysis information 42 having the same structure as the one of FIG. 6 using the first through third impression values SP, EL and NE of each music data and the corresponding music related information. The CPU 60 supplies the music analysis information 42 of each music data to the hard disk drive 62 for storage.

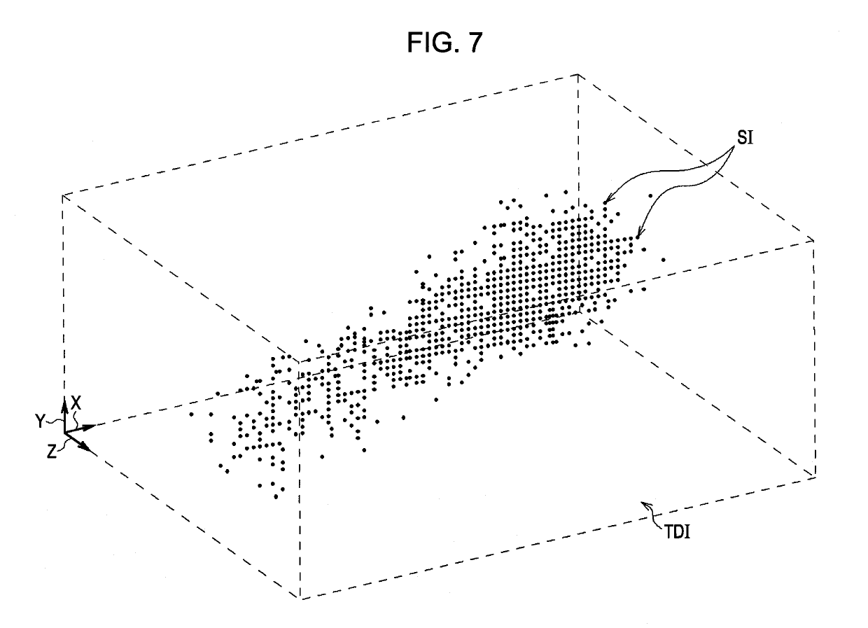

In the same way as shown in FIG. 7, the CPU 60 sets the first through third impression values SP, EL and NE as three-dimensional coordinates. The CPU 60 generates a three-dimensional image TDI containing each music indicator SI in the three-dimensional coordinates.

In the same way as shown in FIG. 8, the CPU 60 converts the three-dimensional image TDI into the music selection image SDI composed of a plurality of two-dimensional images. The plurality of two-dimensional images are generated by projecting the three-dimensional image TDI on two-dimensional planes as if the three-dimensional image TDI is viewed from different viewpoints. When the three-dimensional image TDI is converted into the music selection image SDI, the CPU 30 sets an display mode of each music indicator SI so that the perspective of a plurality of music indicators SI is expressed in accordance with the location position of each music indicator SI within the three-dimensional image TDI on a per viewpoint basis in accordance with a preselected perspective drawing technique.

The CPU 60 supplies the music selection image SDI of each viewpoint to the hard disk drive 62 as music selection image data for storage. As in the data recording and playing apparatus 21, the CPU 60 generates the projection axis image AX for each viewpoint. The CPU 60 sets the projection axis image AX at each viewpoint as projection axis image data and then stores on the hard disk drive 62 the projection axis image data with the music selection image data generated at the same viewpoint mapped thereto. The CPU 60 stores viewpoint position definition information defining the location position of each viewpoint. The CPU 60 also maps the viewpoint position definition information to each of a plurality of units of music selection image data.

When search screen request information requesting a music search screen is transmitted from the data recording and playing apparatus 21 via the network 23, the CPU 60 receives the search screen request information at a network interface 64. In this case, the CPU 60 reads from the hard disk drive 62 the music selection image data generated with respect to the reference viewpoint. The CPU 60 further reads the projection axis image data generated with reference to the reference viewpoint from the hard disk drive 62.

The CPU 60 reads from the hard disk drive 62 the music search screen data pre-stored on the hard disk drive 62. The CPU 60 combines the music selection image data and the projection axis image data with the music search screen data. The CPU 60 thus transmits to the data recording and playing apparatus 21 via the network interface 64 and the network 23 the music search screen data with the music selection image data and projection axis image data combined therewith.

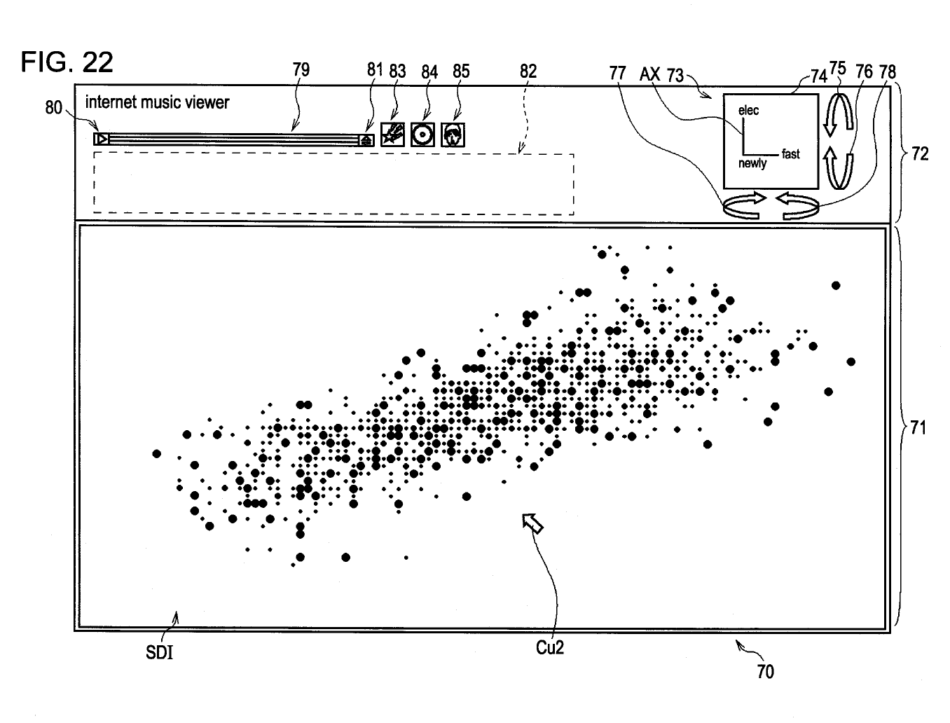

The CPU 30 in the data recording and playing apparatus 21 receives at the network interface 36 the music search screen data transmitted from the music providing apparatus 22. The CPU 30 supplies the music search screen data to the display 39. The CPU 30 displays on the display 39 a music search screen 70 of FIG. 22 based on the music search screen data.

The music search screen 70 contains a music selection partition 71 and an operation partition 72. The music selection partition 71 displays the music selection image SDI. The music selection partition 71 also displays a cursor Cu2 for pointing to the music indicator SI overlaid on the music selection image SDI.

The operation partition 72 in the music search screen 70 contains a viewpoint operation section 73 for pointing to the viewpoint to view the three-dimensional image TDI for modification and for selecting the modified viewpoint. The viewpoint operation section 73 includes an image display area 74. The image display area 74 displays the projection axis image AX generated using the same viewpoint as the music selection image SDI in the music selection partition 71.

The viewpoint operation section 73 contains a viewpoint raising button 75 to the right of the image display area 74. The viewpoint raising button 75 is used to raise the viewpoint to view the three-dimensional image TDI (with space containing the three-dimensional image TDI of FIG. 8 rotating from up to down). The viewpoint operation section 73 also contains a viewpoint lowering button 76 to the right of the image display area 74. The viewpoint lowering button 76 is used to lower the viewpoint to view the three-dimensional image TDI (with space containing the three-dimensional image TDI of FIG. 8 rotating from down to up).

The viewpoint operation section 73 contains a viewpoint right-shifting button 77 below the image display area 74. The viewpoint right-shifting button 77 is used to turn right the viewpoint to view the three-dimensional image TDI (with space containing the three-dimensional image TDI of FIG. 8 rotating leftward). The viewpoint operation section 73 contains a viewpoint left-shifting button 78 below the image display area 74. The viewpoint left-shifting button 78 is used to turn left the viewpoint to view the three-dimensional image TDI (with space containing the three-dimensional image TDI of FIG. 8 rotating rightward).

The operation partition 72 contains a play position indicator bar 79. The play position indicator bar 79 is used to indicate a play position along play time axis of the music data when the music data selected as the music indicator SI on the music selection image SDI is played. A play stop button 80 is arranged at one end of the play position indicator bar 79. The play stop button 80 controls playing of the music data selected as the music indicator SI on the music selection image SDI. A retrieval request button 81 is arranged at the other end of the play position indicator bar 79. The retrieval request button 81 is used to request to retrieve (i.e., download) the music data selected as the music indicator SI on the music selection image SDI.

The operation partition 72 contains a play music notifier section 82. The play music notifier section 82 displays a jacket photograph image and at least part of music related information for the music data currently being played (such as song title, album title, and artist name). The play music notifier section 82 thus notifies the user of what music is provided by the music data currently being played. The operation partition 72 further contains a random selection button 83. The random selection button 83 is used to select randomly a plurality of songs as the music indicators SI on the music selection image SDI.

The operation partition 72 also contains an album search button 84. The album search button 84 is used to designate an album as a search condition and search for a plurality of songs contained in the designated album on the music selection image SDI. The operation partition 72 further contains an artist search button 85. The artist search button 85 is used to designate an artist as a search condition and search for a song of the designated artist on the music selection image SDI.

Using input unit 31, the user may click on one of the viewpoint raising button 75, the viewpoint lowering button 76, the viewpoint right-shifting button 77 and the viewpoint left-shifting button 78 with the music search screen 70 displayed on the display 39. In response, a viewpoint modification command may be issued. The CPU 30 displays a modification direction of the viewpoint in response to the pressed one of the viewpoint raising button 75, the viewpoint lowering button 76, the viewpoint right-shifting button 77 and the viewpoint left-shifting button 78. The CPU 30 generates viewpoint modification request information requesting to modify the viewpoint to view the three-dimensional image TDI. The CPU 30 transmits the viewpoint modification request information to the music providing apparatus 22 via the network interface 36 and the network 23.

The CPU 60 in the music providing apparatus 22 receives and retrieves via the network interface 64 the viewpoint modification request information transmitted from the data recording and playing apparatus 21. The CPU 60 detects the modified viewpoint selected by the data recording and playing apparatus 21 based on the viewpoint position definition information for the music selection image SDI displayed on the data recording and playing apparatus 21 and the modification direction of the viewpoint represented by the viewpoint modification request information.

The user may click on the viewpoint raising button 75 once with the music selection image SDI displayed. The music selection image SDI is generated by the data recording and playing apparatus 21 so that the three-dimensional image TDI is viewed from the reference viewpoint within the music search screen 70. The CPU 60 detects as the modified viewpoint a viewpoint on the upper-slanted frontward side next to and above the reference viewpoint in the direction from down to up. If the user click on the viewpoint lowering button 76 once under the same state on the data recording and playing apparatus 21, the CPU 60 detects as the modified viewpoint a viewpoint on the lower-slanted frontward side next to and below the reference viewpoint in the direction from up to down.

If the user clicks on the viewpoint right-shifting button 77 once under the same state on the data recording and playing apparatus 21, the CPU 60 detects as the modified viewpoint a viewpoint on the right frontward side to the right of the reference viewpoint in the direction from left to right. If the user clicks on the viewpoint left-shifting button 78 once under the same state on the data recording and playing apparatus 21, the CPU 60 detects as the modified viewpoint a viewpoint on the left frontward side to the left of the reference viewpoint in the direction from right to left. In response to the clicking of one of the viewpoint raising button 75, the viewpoint lowering button 76, the viewpoint right-shifting button 77 and the viewpoint left-shifting button 78 on the data recording and playing apparatus 21, the CPU 60 allows the user to select appropriately the viewpoint to view the three-dimensional image TDI in a manner such that the viewpoint is shifted from the current one to the next one.

The CPU 60 detects the modified viewpoint selected by the data recording and playing apparatus 21. In response to the viewpoint position definition information of the detected viewpoint, the CPU 60 reads from the hard disk drive 62 the corresponding music selection image data (i.e., the music selection image data of the music selection image SDI generated with the three-dimensional image TDI viewed from the viewpoint selected on the data recording and playing apparatus 21) and the projection axis image data. The CPU 60 transmits to the data recording and playing apparatus 21 the music selection image data and projection axis image data via the network interface 64 and the network 23.

The CPU 30 in the data recording and playing apparatus 21 receives and retrieves the music selection image data and projection axis image data from the music providing apparatus 22 via the network interface 36. The CPU 30 then supplies to the display 39 the music selection image data and projection axis image data.

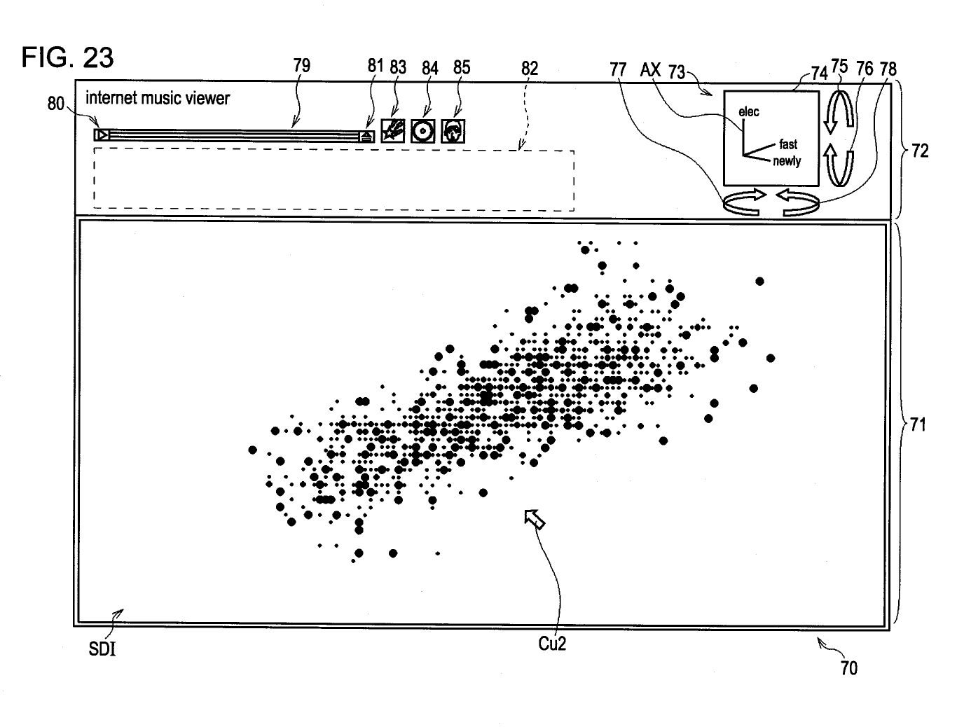

As shown in FIG. 23, the CPU 30 switches from the then displayed projection axis image AX to the projection axis image AX based on the retrieved projection axis image data on the image display area 74 of the music search screen 70. The CPU 30 also switches from the then displayed music selection image SDI to the music selection image SDI based on the retrieved music selection image data on the music selection partition 71 of the music search screen 70. In this way, the CPU 30 switches on the music selection partition 71 of the music search screen 70 from the music selection image SDI to the music selection image SDI generated with the three-dimensional image TDI viewed from the view point selected by the user.

When the three-dimensional image TDI is viewed from one viewpoint, a back music indicator SI may be hidden in the shadow of a plurality of front music indicators SI. The back music indicator SI cannot be displayed in the music selection image SDI generated with reference to that viewpoint. In such a case, the music selection images SDI generated with different viewpoints are appropriately switched within the music selection partition 71 of the music search screen 70 on the data recording and playing apparatus 21. The user can thus view any music indicator SI.

When the music selection images SDI displayed on the music selection partition 71 of the music search screen 70 are switched, the CPU 60 switches the projection axis image AX displayed on the image display area 74. The user can easily recognize the impression of the music indicated by individual music indicator SI.

The user may double click on a left button of the mouse with the cursor Cu2 overlaid on the music selection image SDI. The CPU 30 in the data recording and playing apparatus 21 detects the two-dimensional coordinates at the selected position indicated by the end point of the cursor Cu2 on the music selection image SDI. The CPU 30 transmits to the music providing apparatus 22 via the network interface 36 and the network 23 the selected position information indicating the two-dimensional coordinates at the selected position.

The CPU 60 in the music providing apparatus 22 receives and retrieves the selected position information from the data recording and playing apparatus 21 via the network interface 64. In the same way as described with reference to FIG. 13, the CPU 60 detects the expansion target portion SDA centered on the selected position represented by the selected position information (i.e., the two-dimensional coordinates at the position selected by the user). The expansion target portion SDA falls within the music selection image SDI then supplied to the data recording and playing apparatus 21 (i.e., the music selection image SDI then displayed on the music search screen 70 on the data recording and playing apparatus 21).

The CPU 60 detects as the selected music indicator SI1 a music indicator SI closest to the selected position within the expansion target portion SDA (i.e., having the shortest distance to the selected position within the expansion target portion SDA). The CPU 60 converts back the two-dimensional coordinates of the music indicator SI into the three-dimensional coordinates within the three-dimensional image TDI through calculations reversal to the above-described equations (1) and (2). The CPU 60 further detects the music search region MRA centered on the three-dimensional coordinates of the selected music indicator SI1 within the three-dimensional image TDI.

The CPU 60 detects all music indicators SI located within the music search region MRA from among the plurality of music indicators SI in accordance with the three-dimensional coordinates contained in the music analysis information 42. In the same manner as shown in FIG. 14, the CPU 60 then selects, as candidate music indicators, music indicators SI2 through SI11 of the standard selection number (for example, 10) in the order from music indicators SI2 through SI11 according to the order of near to far distance from the selected music indicator SI1.

In the same manner as described with reference to FIG. 15, the CPU 60 sets the selected music indicator SI1 in a display mode different from the other music display indicators SI2 through SIn within the expansion target portion SDA of the music selection image SDI. The CPU 60 converts the three-dimensional coordinates of the candidate music display indicators SI2 through SI11 into the two-dimensional coordinates in accordance with the above-described equations (1) and (2). In this way, the CPU 30 determines the plurality of candidate music display indicators SI2 through SI11 within the expansion target portion SDA according to the two-dimensional coordinates thereof. The CPU 60 also sets the candidate music display indicators SI2 through SI11 within the expansion target portion SDA to be in a display mode different from the selected music indicator SI1 and a plurality of other music display indicators SIn.

In the same way as described with reference to FIG. 16, the CPU 60 extracts the expansion target portion SDA from the music selection image SDI. The CPU 60 performs an expansion process on the expansion target portion SDA in accordance with a predetermined expansion rate, thereby generating a music selection expansion image SDW equal in size to the original music selection image SDI. The CPU 60 transmits the music selection expansion image SDW as music selection expansion image data to the data recording and playing apparatus 21 via the network interface 64 and the ROM 32.

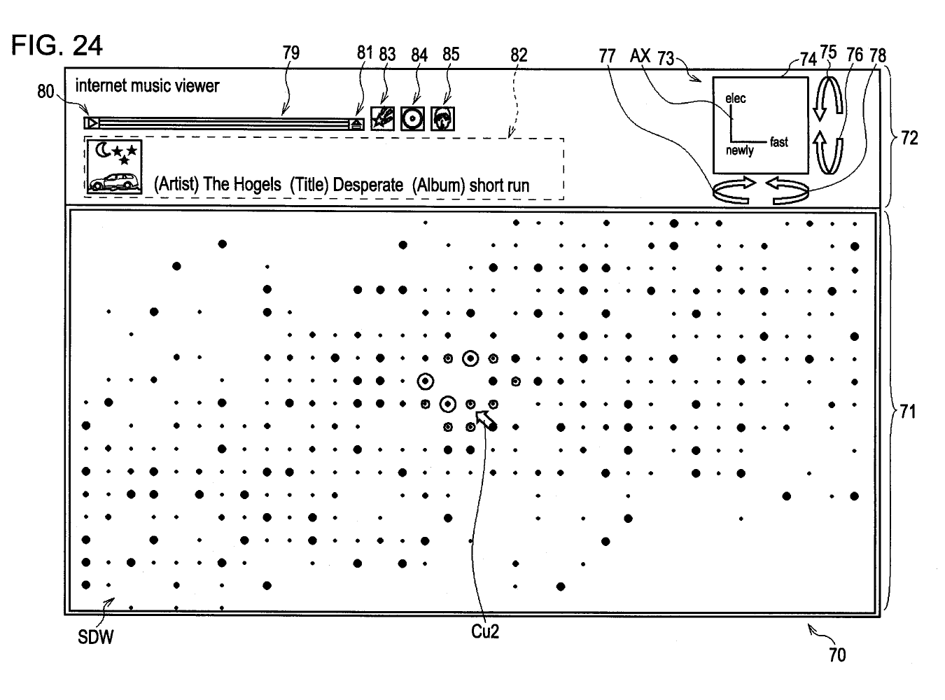

The CPU 30 in the data recording and playing apparatus 21 receives and retrieves the music selection expansion image data from the music providing apparatus 22 via the network interface 36. The CPU 30 then supplies the music selection expansion image data to the display 39. As shown in FIG. 24, the CPU 30 switches from the then-displayed music selection image SDI to the music selection expansion image SDW based on the retrieved music selection expansion image data on the music selection partition 71 of the music search screen 70.

The CPU 60 in the music providing apparatus 22 causes the selected music indicator SI1 selected by the user and the plurality of candidate music display indicators SI2 through SI11 becoming the selection candidates as a result of user selection of the selected music indicator SI1 to be displayed in a display mode different from the other display indicators on the music selection expansion image SDW on the data recording and playing apparatus 21. The CPU 60 displays the projection axis image AX on the image display area 74 of the music search screen 70. Using the projection axis image AX, the CPU 60 thus displays on the music selection expansion image SDW the selected song and the plurality of candidate songs corresponding to the selected music indicator SI1 and the plurality of candidate music display indicators SI2 through SI11.

When the selected music indicator SI1 is detected and the plurality of candidate music display indicators SI2 through SI11 are selected, the CPU 60 reads the music data corresponding to the selected music indicator SI1 from the hard disk drive 62. The CPU 60 extracts the characteristic portion from the music data and then transmits the characteristic portion in a stream form to the data recording and playing apparatus 21 via the network interface 64 and the network 23.

In succession to the transmission, the CPU 60 reads from the hard disk drive 62 the music data, in the near to far distance order starting with the music data corresponding to the music indicator SI2 closest to the selected music indicator SI1 to the music data corresponding to the candidate music display indicators SI3 through SI11. Each time the music data is read, the CPU 60 extracts the characteristic portion from the read music data and then transmits the characteristic portion in a stream form to the data recording and playing apparatus 21 via the network interface 64 and the network 23.

The music selection expansion image SDW is displayed on the music selection partition 71 of the music search screen 70. The CPU 30 in the data recording and playing apparatus 21 receives the characteristic portion of the music data, successively transmitted from the music providing apparatus 22, via the network interface 36 and then plays (stream plays) the characteristic portion through the playing processor 37 and the loudspeaker 38. Within a relatively short period of time, the CPU 60 in the music providing apparatus 22 causes the user to listen to the characteristic portions of the selected song and the plurality of candidate songs corresponding to the selected music indicator SI1 and the plurality of candidate music display indicators SI2 through SI11 and verify whether the song matches (is close to) the user's preference.

The CPU 60 in the music providing apparatus 22 notifies the user of one of the selected music indicator SI1 and the plurality of candidate music display indicators SI2 through SI11 corresponding to the music data currently being played on the data recording and playing apparatus 21. The CPU 60 transmits the characteristic portion of the music data together with the corresponding music related information and the jacket photograph image data to the data recording and playing apparatus 21 via the network interface 64 and the network 23.

In response to the notification from the music providing apparatus 22, the CPU 30 sets in a display mode for playing (for example, in a particular display color selected for playing) the one of the selected music indicator SI1 and the plurality of candidate music display indicators SI2 through SI11 corresponding to the music data currently being played. The CPU 30 receives and retrieves the music related information and jacket photograph image data from the music providing apparatus 22 via the network interface 36 and supplies the received music related information and jacket photograph image data to the display 39.

The CPU 30 displays on the play music notifier section 82 of the music search screen 70 the music related information of the music data currently being played. The CPU 30 also displays on the play music notifier section 82 of the music search screen 70 the jacket photograph image based on the jacket photograph image data. The CPU 60 in the music providing apparatus 22 displays to the user the impression of music of the selected song and the candidate songs based on the currently played music data on the data recording and playing apparatus 21 while also teaching the user the song name of one of the selected music and the candidate music.

The user may click on the play stop button 80 of the music search screen 70 using the input unit 31 with reference to the cursor Cu2 when the characteristic portion of the music data is being played. In response, a one-song play command may be input. The CPU 30 in the data recording and playing apparatus 21 transmits to the music providing apparatus 22 via the network interface 36 and the network 23 delivery request information requesting to deliver in a stream form the entire music data currently being played.

The CPU 60 in the music providing apparatus 22 receives and retrieves the delivery request information from the data recording and playing apparatus 21 via the network interface 64. The CPU 60 reads from the hard disk drive 62 the entire music data requested. The CPU 60 transmits the music data in a stream form to the data recording and playing apparatus 21 via the network interface 64 and the network 23.

The CPU 30 in the data recording and playing apparatus 21 receives the music data from the music providing apparatus 22 via the network interface 36 while playing (stream playing) the received music data through the playing processor 37 and the loudspeaker 38. When the characteristic portions of the plurality of units of music data are consecutively transmitted to the data recording and playing apparatus 21 for playing, the CPU 60 in the music providing apparatus 22 can switch from partial playing to general playing of the music data. The user can thus recognize the general impression of the selected music and the candidate music.

The user may click on the play stop button 80 of the music search screen 70 using the input unit 31 with reference to the cursor Cu2 during the playing of the entire music data. In response, a play stop command may be input. The CPU 30 in the data recording and playing apparatus 21 stops the (stream) playing of the entire music data. The CPU 30 transmits delivery stop request information requesting to stop delivery of the music data to the music providing apparatus 22 via the network interface 36 and the network 23.

The CPU 60 in the music providing apparatus 22 receives and retrieves the delivery stop request information from the data recording and playing apparatus 21 via the network interface 64. In response, the CPU 60 ends the transmission of the entire music data in a stream form to the data recording and playing apparatus 21 and the transmission of the characteristic portion of the music data in a stream form to the data recording and playing apparatus 21. In this way, the CPU 60 stops the transmission of the music data to the data recording and playing apparatus 21 in response to the user's request.

The user may click on the retrieval request button 81 using the input unit 31 with reference to the cursor Cu2 during the playing of the characteristic portions of the music data or the entire music data. In response, a retrieval command may be input. The CPU 30 in the data recording and playing apparatus 21 transmits to the music providing apparatus 22 via the network interface 36 and the network 23 a retrieval request information requesting to retrieve the currently played music data with or without charge. The requested music data is transmitted from the music providing apparatus 22 via the network 23. The CPU 30 receives and retrieves the music data via the network interface 36 and then supplies the music data to the hard disk drive 33 for storage.

Using the input unit 31 (for example, a mouse or a keyboard), the user may perform a selection operation with the cursor Cu2 overlaid on the projection axis image AX with the music selection expansion image SDW displayed on the music selection partition 71 of the music search screen 70. In response, the CPU 30 in the data recording and playing apparatus 21 transmits to the music providing apparatus 22 via the network interface 36 and the network 23 image request information requesting the original music selection image SDI (prior to expansion). The CPU 60 in the music providing apparatus 22 receives and retrieves the image request information from the data recording and playing apparatus 21 via the network interface 64.

Upon receiving the image request information, the CPU 60 reads from the hard disk drive 62 the music selection image data of the music selection image SDI prior to expansion. The CPU 60 transmits the music selection image data to the data recording and playing apparatus 21 via the network interface 64 and the network 23. The CPU 30 in the data recording and playing apparatus 21 receives and retrieves the music selection image data from the music providing apparatus 22 via the network interface 36.

The CPU 30 switches from the music selection expansion image SDW to the original music selection image SDI on the music selection partition 71 of the music search screen 70 by supplying the music selection image data to the display 39. Even if the music selection image SDI is switched to the music selection expansion image SDW on the music selection partition 71 of the music search screen 70, the CPU 60 in the music providing apparatus 22 can easily switch back to the original image in response to the user's request.

The user may move the cursor Cu2 on the music selection image SDI (or the music selection expansion image SDW) using the input unit 31 (for example, a mouse). The CPU 30 in the data recording and playing apparatus 21 waits on standby until the cursor Cu2 stops moving in response to the end of the user operation of the input unit 31. When the cursor Cu2 stops moving on the music selection image SDI (or the music selection expansion image SDW), the CPU 30 detects the two-dimensional coordinates at the end point position pointed to by the end of the cursor Cu2 at that moment. The CPU 30 starts time counting with the internal timer at the stop of the movement of the cursor Cu2.

If the user re-starts moving the cursor Cu2 on the music selection image SDI (or the music selection expansion image SDW) using the input unit 31 before the introduction waiting time has elapsed, the CPU 30 stops time counting and resets the timer. If the introduction waiting time has elapsed on the timer with the cursor Cu2 remaining stationary, the CPU 30 transmits photograph request information requesting the jacket photograph image data to the music providing apparatus 22 via the network interface 36 and the network 23. The photograph request information indicates the two-dimensional coordinates at the end point position at the stop of the movement of the cursor Cu2 on the music selection image SDI (or the music selection expansion image SDW).

The CPU 60 in the music providing apparatus 22 receives and retrieves the photograph request information from the data recording and playing apparatus 21 via the network interface 64. The CPU 60 detects a music indicator SI closest to the end point position of the cursor Cu2 based on the two-dimensional coordinates at the end point position of the cursor Cu2 indicated by the photograph request information and the two-dimensional coordinates of the plurality of music indicators SI in the music selection image SDI (or the music selection expansion image SDW) supplied to the data recording and playing apparatus 21.

Upon detecting the music indicator SI closest to the end point position of the cursor Cu2, the CPU 60 converts the two-dimensional coordinates of the detected music indicator SI into three-dimensional coordinates within the three-dimensional image TDI in accordance with calculation operations reversal to the above-described equations (1) and (2). Based on the three-dimensional coordinates and the music analysis information 42, the CPU 60 determines the music data corresponding to the music indicator SI closest to the end point position. The CPU 60 reads from the hard disk drive 62 the jacket photograph image data corresponding to the determined music data. The CPU 60 transmits the jacket photograph image data to the data recording and playing apparatus 21 via the network interface 64 and the network 23.

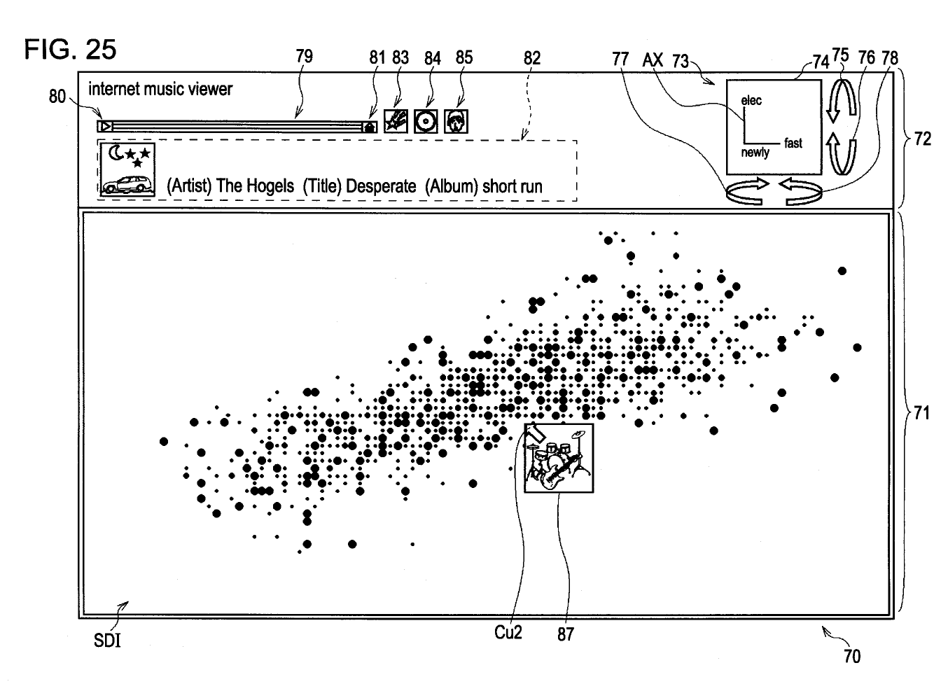

The CPU 30 in the data recording and playing apparatus 21 receives and retrieves the jacket photograph image data from the music providing apparatus 22 via the network interface 36 and supplies the received jacket photograph image data to the display 39. As shown in FIG. 25, the CPU 30 displays on the display 39 a rectangular jacket photograph image 87 based on the jacket photograph image data with one corner of the jacket photograph image 87 placed at the end point position of the cursor Cu2 on the music search screen 70.

Each time the introduction waiting time has elapsed since the stop of the movement of the cursor Cu2 on the music selection image SDI (or the music selection expansion image SDW) on the data recording and playing apparatus 21, the CPU 60 in the music providing apparatus 22 provides the jacket photograph image 87 for the music indicator SI closest to the end point position of the cursor Cu2. Using the jacket photograph image 87, the CPU 60 thus introduces the music indicated by the music indicator SI pointed to by the cursor Cu2 on the music selection image SDI (or the music selection expansion image SDW) on the data recording and playing apparatus 21.

The CPU 30 in the data recording and playing apparatus 21 overlays the jacket photograph image 87 on the music selection image SDI (or the music selection expansion image SDW) on the music search screen 70. Depending on the display position of the jacket photograph image 87, one or a plurality of music indicators SI may be hidden in the shadow of the jacket photograph image 87. As previously described, if the cursor Cu2 starts being moved again after the jacket photograph image 87 starts being displayed, the CPU 30 quits displaying the jacket photograph image 87 (i.e., causes the jacket photograph image 87 to disappear from the screen).

If display end time of the jacket photograph image 87 is reached with the cursor Cu2 remaining stationary, the CPU 30 quits displaying the jacket photograph image 87. In this way, the CPU 30 prevents the jacket photograph image 87 from presenting difficulty in the user operation in which the user recognizes the geometry of the plurality of music indicators SI on the music selection image SDI (or the music selection expansion image SDW) and the user selects a position using the cursor Cu2.

If playing (steam playing) of the music data is in progress at the moment the jacket photograph image 87 is overlaid on the music selection image SDI (or the music selection expansion image SDW) in the music search screen 70, the CPU 30 continues to play the music data. If the music data is not played at the moment the jacket photograph image 87 is overlaid on the music selection image SDI (or the music selection expansion image SDW) in the music search screen 70, the CPU 30 transmits the music data for the jacket photograph image 87 (i.e., the music data for the music indicator SI closest to the end point position) in a stream form as delivery request information to the music providing apparatus 22 via the network interface 36 and the network 23.

The CPU 60 in the music providing apparatus 22 receives and retrieves the delivery request information from the data recording and playing apparatus 21 via the network interface 64 and reads the music data responsive to the delivery request information from the hard disk drive 62. The CPU 60 extracts a characteristic portion from the music data and transmits the characteristic portion in a stream form to the data recording and playing apparatus 21 via the network interface 64 and the network 23. The CPU 30 in the data recording and playing apparatus 21 receives via the network interface 36 the characteristic portion of the music data transmitted from the music providing apparatus 22 while playing (stream playing) the characteristic portion through the playing processor 37 and loudspeaker 38.

The CPU 60 in the music providing apparatus 22 transmits to the data recording and playing apparatus 21 via the network interface 64 and the network 23 the corresponding music related information and jacket photograph image data together with the characteristic portion of the music data. The CPU 30 in the data recording and playing apparatus 21 receives and retrieves via the network interface 36 the music related information and jacket photograph image data transmitted from the music providing apparatus 22. The CPU 30 supplies the music related information and jacket photograph image data to the display 39. The CPU 30 thus displays on the play music notifier section 82 of the music search screen 70 a jacket photograph image based on the music related information and jacket photograph image data for the music data currently being displayed (stream displayed).

The CPU 60 in the music providing apparatus 22 causes the user to listen actually to the music indicated by the music indicator SI pointed to by the cursor Cu2 on the data recording and playing apparatus 21, thereby allowing the user to verify the impression of the music. With the display content on the play music notifier section 82 on the data recording and playing apparatus 21, the CPU 60 teaches the user the name of the song based on the music data currently being played (stream played).

The user may click on the play stop button 80 on the music search screen 70 using the input unit 31 (such as a mouse) with reference to the cursor Cu2. In response, a one-song play command may be input. The CPU 30 in the data recording and playing apparatus 21 re-starts (stream) playing the music data from the beginning thereof together with the music providing apparatus 22. The CPU 30 allows the user to recognize the general impression of the music of the music indicator SI pointed to by the cursor Cu2.

The user may click on the album search button 84 on the music search screen 70 using the input unit 31 (such as a mouse) with reference to the cursor Cu2 and input a desired album name as a search condition. In response, the CPU 30 displays the input album name and transmits the search request information requesting search to the music providing apparatus 22 via the network interface 36 and the network 23. The CPU 60 in the music providing apparatus 22 receives and retrieves the search request information from the data recording and playing apparatus 21 via the network interface 64.

The CPU 60 searches for one or a plurality of units of music data recorded on an album having the input album name based on the album name as the search condition indicated by the search request information and the content of a plurality of pieces of music related information. Based on the music analysis information 42 of one or a plurality of units of music data searched (i.e., three-dimensional coordinates), the CPU 60 calculates two-dimensional coordinates of one or a plurality of music indicators SI corresponding to one or plurality of pieces of music data searched.

The CPU 60 changes one or a plurality of music indicators SI placed in the two-dimensional coordinates in the music selection image SDI provided to the data recording and playing apparatus 21 in a display mode (for example, in a display color) different from a display mode of the other music indicators SI. The CPU 60 transmits to the data recording and playing apparatus 21 via the network interface 64 and the network 23 the music selection image data of the music selection image SDI thus processed according to the search condition.

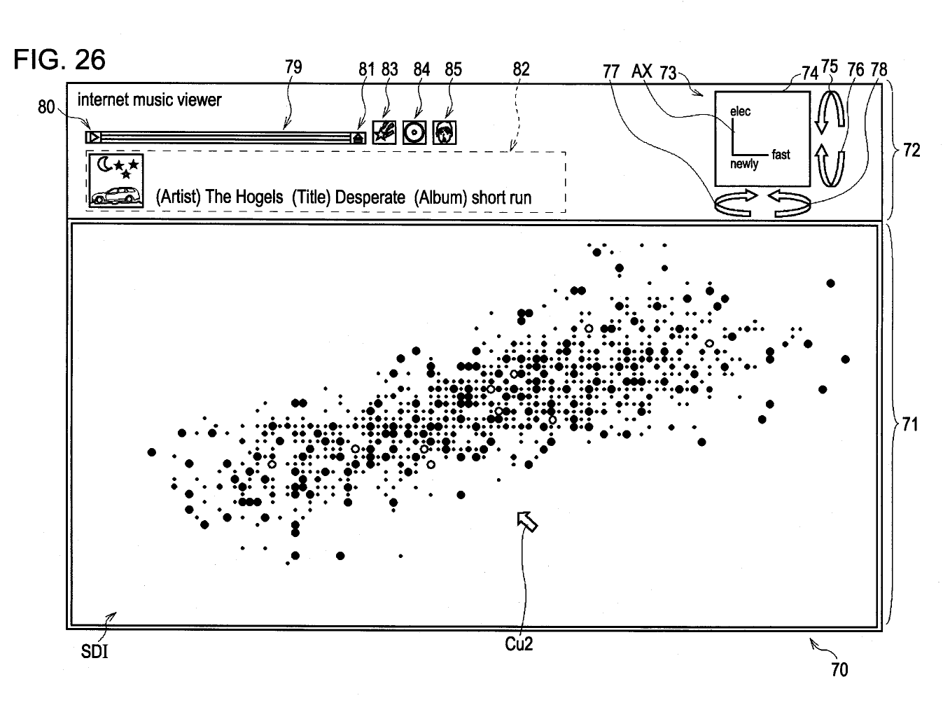

The CPU 30 in the data recording and playing apparatus 21 receives and retrieves the music selection image data from the music providing apparatus 22 via the network interface 36. By supplying the music selection image data to the display 39, the CPU 30 displays on the music search screen 70 the music selection image SDI of one or a plurality of music indicators SI indicating the music searched according to the search condition in the display mode different from the display mode of the other music indicators SI as shown in FIG. 26. The CPU 60 in the music providing apparatus 22 thus displays easily and reliably to the user the impression of the music recorded in the album specified in the search condition on the data recording and playing apparatus 21.

The CPU 60 further successively reads from the hard disk drive 62 the music data of one or the plurality of songs searched. The CPU 60 extracts characteristic portions of the music data and transmits the extracted characteristic portions in a stream form to the data recording and playing apparatus 21 via the network interface 64 and the network 23. The CPU 60 causes the characteristic portions of the music data searched according to the album as the search condition on the data recording and playing apparatus 21. The CPU 60 causes the user to listen actually to the music recorded on the album specified in the search condition on the data recording and playing apparatus 21, thereby allowing the user to verify the impression of the music.

The user may click on the artist search button 85 of the music search screen 70 using the input unit 31 (such as a mouse) with reference to the cursor Cu2 and enter a desired artist name as the search condition. In response, the CPU 30 in the data recording and playing apparatus 21 displays the input artist name and transmits the search request information requesting search to the music providing apparatus 22 via the network interface 36 and the network 23. In the same manner as previously discussed, the CPU 60 in the music providing apparatus 22 searches for music according to the artist name as the search condition and processes the music selection image data in response to the search results and then transmits the resulting music selection image data to the data recording and playing apparatus 21.

The CPU 30 in the data recording and playing apparatus 21 displays on the music search screen 70 one or a plurality of music indicators SI representing music searched according to the search condition in a display mode different from a display mode of the other music indicators SI. In this way, the CPU 60 in the music providing apparatus 22 displays easily and reliably to the user the impression of the music of the artist specified in the search condition on the data recording and playing apparatus 21.

The CPU 60 causes the characteristic portions of the music data searched according to the artist as the search condition to be played on the data recording and playing apparatus 21. The CPU 60 causes the user to listen actually to the music of the artist specified in the search condition on the data recording and playing apparatus 21, thereby allowing the user to verify the impression of the music.

The user may click on the random selection button 83 of the music search screen 70 using the input unit 31 with reference to the cursor Cu2. The CPU 30 in the data recording and playing apparatus 21 transmits random selection request information requesting random selection of music to the music providing apparatus 22 via the network interface 36 and the network 23. The CPU 60 in the music providing apparatus 22 receives and retrieves the random selection request information from the data recording and playing apparatus 21 via the network interface 64.

In response to the random selection request information, the CPU 60 selects randomly music indicators SI of a predetermined number from among a plurality of music indicators SI within the music selection image SDI supplied to the data recording and playing apparatus 21. The CPU 60 also displays the selected music indicators SI of the predetermined number in a display mode (for example, in a display color) different from a display mode of the other music indicators SI. The CPU 60 transmits the music selection image data of the music selection image SDI processed in response to the request to select randomly music to the data recording and playing apparatus 21 via the network interface 64 and the network 23.

The CPU 30 in the data recording and playing apparatus 21 receives and retrieves the music selection image data from the music providing apparatus 22 via the network interface 36. By supplying toe music selection image data to the display 39, the CPU 30 displays on the music search screen 70 the music selection image SDI of the music indicators SI of the predetermined number indicating randomly selected music in the display mode different from the display mode of the other music indicators SI.

The CPU 60 in the music providing apparatus 22 successively reads the selected units of music data of the predetermined number from the hard disk drive 62. The CPU 60 extracts the characteristic portions of the music data and transmits the characteristic portions in a stream form to the data recording and playing apparatus 21 via the network interface 64 and the network 23. The CPU 60 plays the characteristic portions of the randomly selected music data units of the predetermined number on the data recording and playing apparatus 21. The CPU 60 thus introduces music, by allowing the user to listen actually to the randomly selected songs of the predetermined number.

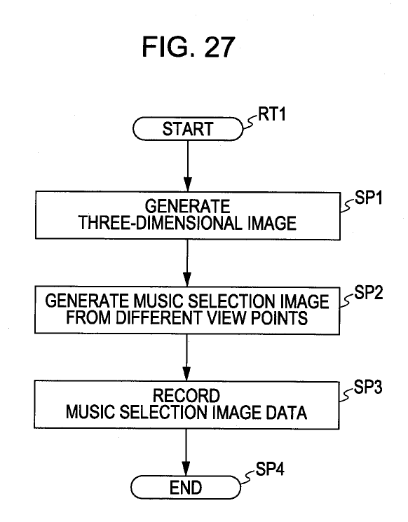

An image generation process RT1 of the data recording and playing apparatus 21 for generating the music selection image SDI is described below with reference to a flowchart of FIG. 27. The user may input a power-off command using the input unit 31. The CPU 30 in the data recording and playing apparatus 21 shifts to a standby state, and starts the image generation process RT1 of FIG. 27 in accordance with a display program stored on one of the ROM 32 and the hard disk drive 33. At the start of the image generation process RT1, the CPU 30 reads the music analysis information 42 from the hard disk drive 33 in step SP1. The CPU 30 places the music indicator SI in the three-dimensional coordinates as the first through third impression values SP, EL and NE contained in the music analysis information 42 and generates the three-dimensional image TDI. Processing proceeds to step SP2.

In step SP2, the CPU 30 projects the three-dimensional image TDI to two-dimensional planes, as if the three-dimensional image TDI is viewed from different viewpoints, and generates the music selection image SDI constructed of a plurality of two-dimensional images. Processing proceeds to step SP3. On each music selection image SDI, the CPU 30 sets the display mode of the music indicator SI so that the plurality of music indicators SI are displayed in perspective in accordance with the layout position of each of the plurality of music indicators SI (namely, in accordance with the distance from the viewpoint) within the three-dimensional image TDI with reference to the corresponding viewpoint.

In step SP3, the CPU 30 records the plurality of music selection images SDI thus generated on the hard disk drive 33 as the music selection image data. Processing proceeds to step SP4. In step SP4, the CPU 30 ends the image generation process RT1.

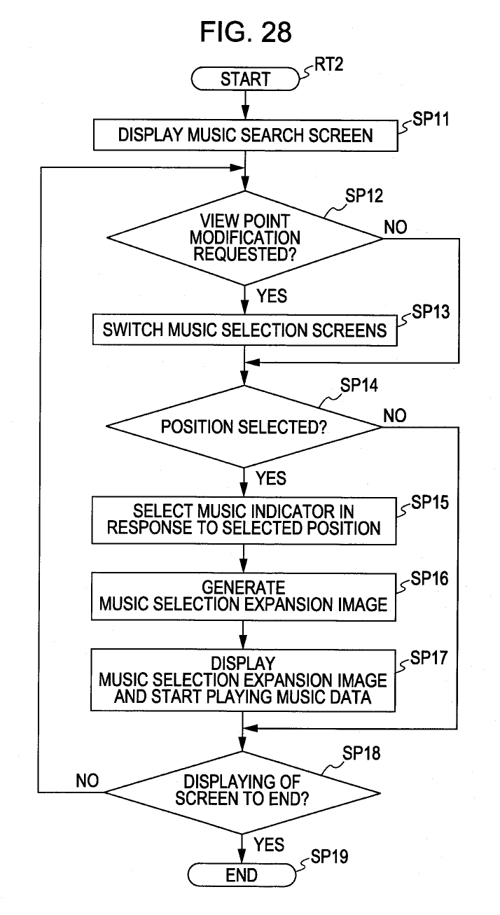

A first display process RT2 of the data recording and playing apparatus 21 for displaying the music selection image SDI is described below with reference to a flowchart of FIG. 28. When the user inputs a music selection request via the input unit 31, the CPU 30 starts the first display process RT2 of FIG. 28 in accordance with the display program. When the first display process RT2 starts, the CPU 30 reads from the hard disk drive 33 the music selection image data and the music search screen data generated with respect to the viewpoint. The CPU 30 outputs to the display 39 the music selection image data with the music search screen data combined therewith. The CPU 30 displays on the display 39 the music search screen 45 with the music selection image SDI set therein. Processing proceeds to step SP12.

In step SP12, the CPU 30 determines whether an instruction to modify the viewpoint to view the three-dimensional image TDI has been issued. An affirmative answer to the determination in step SP12 shows that the user has requested that the music selection image SDI displayed on the music search screen 45 be modified to the music selection image SDI generated with the three-dimensional image TDI viewed from a viewpoint different from a viewpoint of the previous music selection image SDI. In response to the affirmative answer, the CPU 30 proceeds to step SP13.

In step SP13, the CPU 30 reads from the hard disk drive 33 the music selection image data corresponding to the modified viewpoint selected by the user. The CPU 30 then recombines the music selection image data with the music search screen data and outputs the resulting data to the display 39. The CPU 30 thus switches the music search screen 45 on the display 39 from the music selection image SDI of the unmodified viewpoint to the music selection image SDI with the three-dimensional image TDI viewed from the modified viewpoint selected by the user. Processing proceeds to step SP14.

In step SP14, the CPU 30 determines whether the user has selected a position on the music selection image SDI on the music search screen 45. An affirmative answer to the determination in step SP14 shows that the user has selected a position for selecting a preferred song on the music selection image SDI. In response to the affirmative answer, the CPU 30 proceeds to step SP15.

In step SP15, the CPU 30 detects the expansion target portion SDA centered on the selected position within the music selection image SDI and detects within the expansion target portion SDA a music indicator SI closest to the selected position as a selected music indicator SI1 representing the selected music at the position selected by the user. The CPU 30 converts the two-dimensional coordinates of the selected music indicator SI1 detected within the expansion target portion SDA into three-dimensional coordinates and detects the music search region MRA centered on the three-dimensional coordinates of the selected music indicator SI1 within the three-dimensional image TDI. The CPU 30 selects music indicators SI of the standard selection number in the order from music indicators SI2 through SI11 according to the order of near to far distance from the selected music indicator SI1 within the music search region MRA as music indicators SI2 through SI11 that are likely to be selected by the user.

In step SP16, the CPU 30 sets the selected music indicator SI1 and the plurality of candidate music display indicators SI2 through SI11 in a display mode (for example, in a different display color) different from the other music display indicators SIn within the expansion target portion SDA of the music selection image SDI. The CPU 30 generates the music selection expansion image SDW by expanding the expansion target portion SDA. Processing proceeds to step SP17. In step SP17, the CPU 30 combines the data of the music selection expansion image SDW with the music search screen data and supplies the resulting data to the display 39. The CPU 30 switches the music search screen 45 on the display 39 from the music selection image SDI to the music selection expansion image SDW. The CPU 30 starts playing a plurality of pieces of music data corresponding to the selected music indicator SI1 and the plurality of candidate music display indicators SI2 through SI11 and starts displaying on the play music notifier section 52 the music related information corresponding to the music data currently being played. Processing proceeds to step SP18.

In step SP18, the CPU 30 determines whether to quit displaying the music search screen 45. A non-affirmative answer to the determination in step SP18 shows that the user is currently selecting a desired song using the music search screen 45. In response to the non-affirmative answer, the CPU 30 returns to step SP12.

The non-affirmative answer to the determination in step SP12 shows that any position is selected on the music selection image SDI without the user's intervention to modify the music selection image SDI in the music search screen 45 or shows that the user is monitoring the music selection image SDI in the music search screen 45 to determine whether to modify the viewpoint or select the position. In response to the non-affirmative answer, the CPU 30 proceeds to step SP14 with step SP13 skipped.

A non-affirmative answer to the determination in step SP14 shows that the user is monitoring the music selection image SDI in the music search screen 45 to determine whether to modify the viewpoint or select the position. In response to the non-affirmative answer, the CPU 30 proceeds to step SP18.

The CPU 30 teaches the user the impression of a plurality of songs as the location positions of the music indicators SI in the music selection image SDI. When the music selection image SDI is selected as the selected position on the music selection image SDI, the CPU 30 causes the user to listen actually to the selected song indicated by the selected music indicator SI, thereby allowing the user to verify whether the song matches (is close to) the user's preference. The CPU 30 thus allows the user to select the song to the user's preference by referring to the location positions of the plurality of music indicators SI on the music selection image SDI and by listening to the song indicated by the music indicator SI.

The affirmative answer to the determination in step SP18 shows that the user has selected the desired song and requested to quit displaying the music search screen 45. In response to the affirmative answer, the CPU 30 returns to step SP19 to end the first display process RT2.

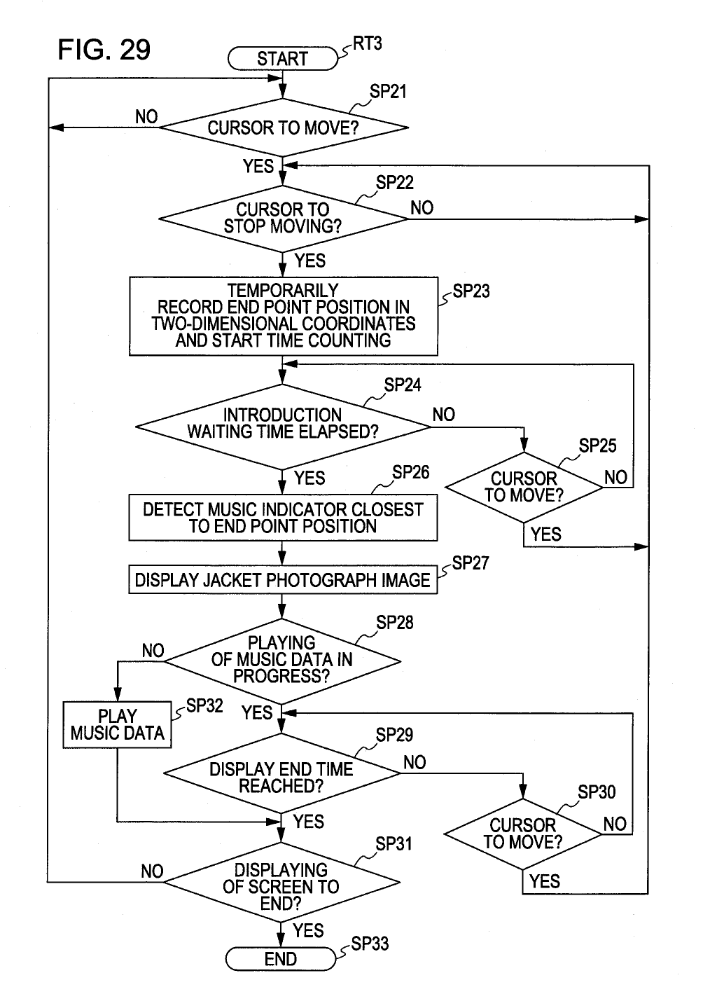

A music introduction process RT3 of the data recording and playing apparatus 21 for introducing the song to the user is described below with reference to a flowchart of FIG. 29. With the music search screen 45 displayed on the display 39, the CPU 30 starts the music introduction process RT3 of FIG. 29 in accordance with the display program. With the music introduction process RT3 starting, the CPU 30 waits on standby in step SP 21 until the user starts moving the cursor Cu1 on the music selection image SDI (or the music selection expansion image SDW) in the music search screen 45 by operating the mouse. When the cursor Cu1 starts moving on the music selection image SDI (or the music selection expansion image SDW), the CPU 30 proceeds to step SP22.

In step SP22, the CPU 30 waits on standby until the movement of the cursor Cu1 stops on the music selection image SDI (or the music selection expansion image SDW). The user may quit moving the cursor Cu1 on the music selection image SDI (or the music selection expansion image SDW) using the mouse. The CPU 30 proceeds to step SP23. In step SP23, the CPU 30 temporarily stores the two-dimensional coordinates at the end point position of the cursor Cu1 at the moment the cursor Cu1 stops moving on the music selection image SDI (or the music selection expansion image SDW) and starts time counting on the timer. Processing proceeds to step SP24.

In step SP24, the CPU 30 determines whether the introduction waiting time period has elapsed on the timer. If it is determined in step SP24 that the introduction waiting time period has not elapsed, processing proceeds to step SP25. In step SP25, the CPU 30 determines whether to move the cursor Cu1 on the music selection image SDI (or the music selection expansion image SDW). An affirmative answer to the determination in step SP25 shows that the user had operated the mouse when the introduction waiting time elapsed after the stop of the movement of the cursor Cu1 and that the cursor Cu1 thus starts moving on the music selection image SDI (or the music selection expansion image SDW). In response to the affirmative answer, the CPU 30 returns to step SP22.

A non-affirmative answer to the determination in step S25 shows that the user has not operated the mouse since the stop of the movement of the cursor Cu1 on the music selection image SDI (or the music selection expansion image SDW). In response to the non-affirmative answer, the CPU 30 returns to step SP24. The CPU 30 monitors the timer as to whether the introduction waiting time has elapsed with the cursor Cu1 remaining stationary since the stop of the cursor Cu1 on the music selection image SDI (or the music selection expansion image SDW). An affirmative answer to the determination in step SP24 shows that the introduction waiting time has elapsed on the timer with the cursor Cu1 remaining stationary since the stop of the movement of the cursor Cu1 on the music selection image SDI (or the music selection expansion image SDW). In response to the affirmative answer, the CPU 30 proceeds to step SP26.

In step SP26, the CPU 30 detects the music indicator SI closest to the end point position on the music selection image SDI (or the music selection expansion image SDW) based on the two-dimensional coordinates of the temporarily stored end point position and the two-dimensional coordinates of the plurality of music indicators SI. Processing proceeds to step SP27. In step SP27, the CPU 30 displays the jacket photograph image 55 for the music indicator SI closest to the end point position of the cursor Cu1 overlaid on the music selection image SDI (or the music selection expansion image SDW). Processing proceeds to step SP28.

When the jacket photograph image 55 is displayed on the music selection image SDI (or the music selection expansion image SDW), the CPU 30 determines in step SP28 whether other music data different from the music data corresponding to the jacket photograph image 55 is currently being played. An affirmative answer to the determination in step SP28 shows that the user stops moving the cursor Cu1 after moving the cursor Cu1 on the music selection image SDI (or the music selection expansion image SDW) using the mouse during the playing of the selected song or the plurality of candidate songs. In response to such a affirmative answer, the CPU 30 proceeds to step SP29.

In step SP29, the CPU 30 determines whether the timer has reached the display end time. The timer starts time counting at the beginning of the displaying of the jacket photograph image 55. If the timer has not reached the display end time, processing proceeds to step SP30 with the jacket photograph image 55 remaining displayed. In step SP30, the CPU 30 determines whether to move the cursor Cu1 on the music selection image SDI (or the music selection expansion image SDW). An affirmative answer to the determination in step SP30 shows that the user had started moving the cursor Cu1 on the music selection image SDI (or the music selection expansion image SDW) using the mouse when the display end time was reached. In response to such an affirmative answer, the CPU 30 forces the music selection partition 46 to quit displaying the jacket photograph image 55.

A non-affirmative answer to the determination in step SP30 shows that the user has never operated the mouse since the start of the displaying of the jacket photograph image 55. In response to the non-affirmative answer, the CPU 30 returns to step S29 with the jacket photograph image 55 remaining displayed. In other words, when the jacket photograph image 55 is displayed, the CPU 30 monitors whether the timer has reached the display end time with the cursor Cu1 remaining stationary. The affirmative answer to the determination in step SP29 shows that the cursor Cu1 had been stationary since the start of the displaying of the jacket photograph image 55 when the timer reached the display end time. In response to the affirmative answer, the CPU 30 quits displaying the jacket photograph image 55 and proceeds to step SP31.

In step SP31, the CPU 30 determines whether to quit displaying the music search screen 45. A non-affirmative answer to the determination in step SP31 shows that the user is selecting a desired song using the music search screen 45. In response to the non-affirmative answer, the CPU 30 returns to step SP21. A non-affirmative answer to the determination in step SP28 shows that the user stops moving the cursor Cu1 after moving the cursor Cu1 on the music selection image SDI (or the music selection expansion image SDW) using the mouse with no music data played. In response to the non-affirmative answer, the CPU 30 returns to step SP32.

In step SP32, the CPU 30 plays the characteristic portions of the music data corresponding to the jacket photograph image 55 while displaying the music related information of the music data on the play music notifier section 52. Processing proceeds to step SP31. An affirmative answer to the determination in step SP31 shows that the user quits displaying the music search screen 45 with a desired song selected. In response to the affirmative answer, the CPU 30 ends the music introduction process RT3.

The CPU 60 in the music providing apparatus 22 performs the same process as the image generation process RT1 discussed with reference to FIG. 27, thereby generating the three-dimensional image TDI based on a great deal of music data and generating the a plurality of music selection images SDI using different viewpoints. The CPU 60 stores the plurality of music selection images SDI as the music selection image data on the hard disk drive 62. In cooperation with the data recording and playing apparatus 21, the CPU 60 then performs a music selection process for allowing the user to select a desired song.

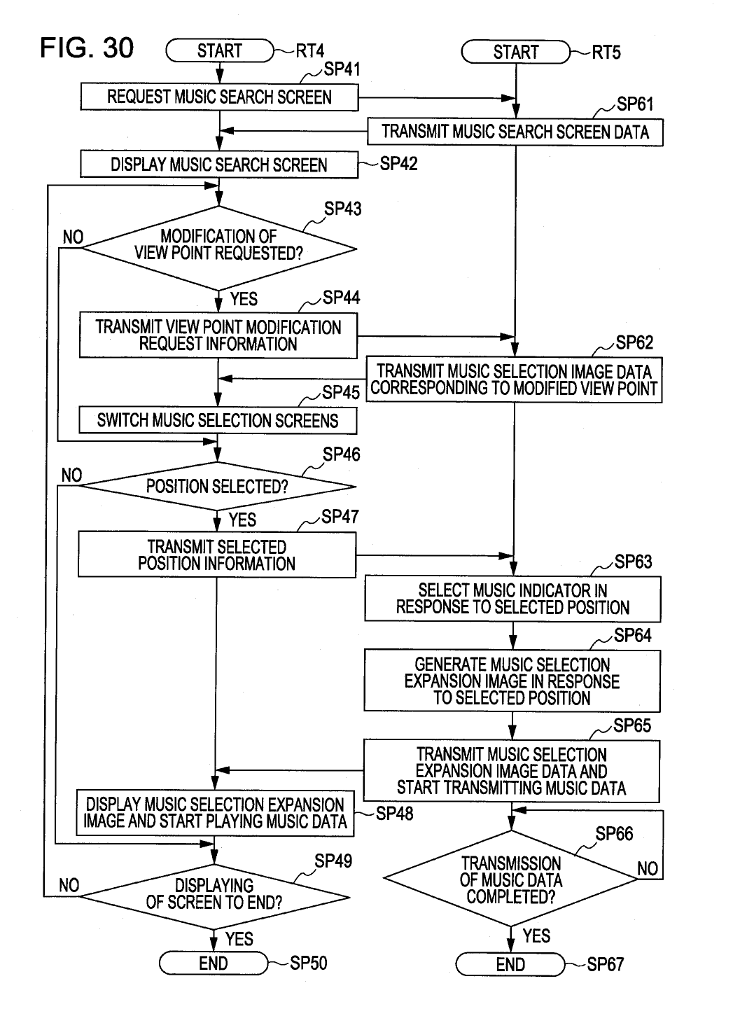

The music selection process of the music providing apparatus 22 is described below with reference to a flowchart of FIG. 30. The music providing apparatus 22 performs the music selection process in cooperation with the data recording and playing apparatus 21. The user may input a search screen retrieval command requesting to retrieve the music search screen 70 using the input unit 31. The CPU 30 in the data recording and playing apparatus 21 starts a second display process RT4 of FIG. 30 in accordance with the display program. With the second display process RT4 starting, the CPU 30 transmits search screen request information to the music providing apparatus 22 in step SP41. Processing proceeds to step SP42.

When communication is established with the data recording and playing apparatus 21, the CPU 60 in the music providing apparatus 22 starts a first image providing process RT5 of FIG. 30 in accordance with an image providing program recorded one of the ROM 61 and the hard disk drive 62. With the first image providing process RT5 starting, the CPU 60 receives the search screen request information from the data recording and playing apparatus 21 in step SP61. In response to the received search screen request information, the CPU 60 reads from the hard disk drive 62 the music selection image data and the projection axis image data generated with respect to the reference viewpoint and the music search screen data. The CPU 60 combines the read music search screen data with the music selection image data and projection axis image data and transmits the combined data to the data recording and playing apparatus 21. Processing proceeds to step SP62.

In step SP42, the CPU 30 in the data recording and playing apparatus 21 receives the music search screen data from the music providing apparatus 22 and supplies the received music search screen data to the display 39. The CPU 30 displays on the display 39 the music search screen 70 with the music selection image SDI and projection axis image AX contained therewithin. Processing proceeds to step SP43. In step SP43, the CPU 30 determines whether a command to modify the viewpoint to view the three-dimensional image TDI has been issued. An affirmative answer to the determination in step SP43 shows that the user has requested that the music selection image SDI displayed on the music search screen 70 be modified to the music selection image SDI that is generated with the three-dimensional image TDI viewed from the viewpoint different from the viewpoint of the original music selection image SDI. In response to the affirmative answer, the CPU 30 proceeds to step SP44.

In step SP44, the CPU 30 transmits the viewpoint modification request information to the music providing apparatus 22 and proceeds to step SP45. The viewpoint modification request information indicates a direction of modification in the viewpoint selected by the user on the music search screen 70 and requests to modify the viewpoint of the three-dimensional image TDI. In step SP62, the CPU 60 in the music providing apparatus 22 receives the viewpoint modification request information from the data recording and playing apparatus 21. The CPU 60 detects the modified viewpoint based on the viewpoint position definition information corresponding to the music selection image SDI displayed on the data recording and playing apparatus 21 and the direction of modification of the viewpoint indicated by the viewpoint modification request information. The CPU 60 reads from the hard disk drive 62 the music selection image data corresponding to the modified viewpoint and the projection axis image data and then transmits the music selection image data and projection axis image data to the data recording and playing apparatus 21. Processing proceeds to step SP63.

In step SP45, the CPU 30 in the data recording and playing apparatus 21 receives the music selection image data and projection axis image data from the music providing apparatus 22 and supplies the music selection image data and projection axis image data to the display 39. The CPU 30 thus switches the music search screen 70 on the display 39 from the music selection image SDI at the unmodified viewpoint to the music selection image SDI generated with the three-dimensional image TDI viewed from the modified viewpoint selected by the user. The CPU 30 also switches from the projection axis image AX at the unmodified viewpoint to the projection axis image AX at the modified viewpoint. Processing proceeds to step SP46.

In step SP46, the CPU 30 determines whether the user has selected a position on the music selection image SDI on the music search screen 70. An affirmative answer to the determination in step SP46 shows that the user has selected a position for selecting a song having a preferred impression on the music selection image SDI. In response to the affirmative answer, the CPU 30 proceeds to step SP47. In step SP47, the CPU 30 transmits to the music providing apparatus 22 the selected position information indicating two-dimensional coordinates at the position selected by the user on the music selection image SDI. Processing proceeds to step SP48.

In step SP63, the CPU 60 in the music providing apparatus 22 receives the selected position information from the data recording and playing apparatus 21. The CPU 60 detects the expansion target portion SDA centered on the selected position in the music selection image SDI supplied to the data recording and playing apparatus 21. The CPU 60 detects, as the selected music indicator SI1 indicating the song selected as the position by the user, the music indicator SI closest to the selected position in the expansion target portion SDA. The CPU 60 converts back the two-dimensional coordinates at the selected music indicator SI1 detected in the expansion target portion SDA into the three-dimensional coordinates, and detects the music search region MRA centered on the three-dimensional coordinates at the selected music indicator SI1 in the three-dimensional image TDI. The CPU 60 selects music indicators SI of the standard selection number in the order from music indicators SI2 through SI11 according to the order of near to far distance from the selected music indicator SI1 within the music search region MRA as music indicators SI2 through SI11 that are likely to be selected by the user. Processing proceeds to step SP64.

In step SP64, the CPU 30 sets the selected music indicator SI1 and the plurality of candidate music display indicators SI2 through SI11 in a display mode (for example, in a different display color) different from the other music display indicators SIn within the expansion target portion SDA on the music selection image SDI. The CPU 30 generates the music selection expansion image SDW by expanding the expansion target portion SDA. Processing proceeds to step SP65.

In step SP65, the CPU 60 transmits the music selection expansion image SDW as the music selection expansion image data to the data recording and playing apparatus 21. The CPU 60 reads successively in order from the hard disk drive 62 the plurality of units of music data of the selected music indicator SI1 and the plurality of candidate music display indicators SI2 through SI11 and starts transmitting the read music data to the data recording and playing apparatus 21. The CPU 60 also reads from the hard disk drive 62 the plurality of units of music related information for the selected music indicator SI1 and the plurality of candidate music display indicators SI2 through SI11 and transmits the read music related information to the data recording and playing apparatus 21. Processing proceeds to step SP66.

In step SP48, the CPU 30 in the data recording and playing apparatus 21 receives the music selection expansion image data from the music providing apparatus 22 and then supplies the received music selection expansion image data to the display 39. The CPU 30 switches from the music selection image SDI to the music selection expansion image SDW on the music search screen 70 on the display 39. The CPU 30 receives the music data from the music providing apparatus 22 while starting playing the music data. The CPU 30 starts receiving the music related information from the music providing apparatus 22 while supplying the music related information to the display 39. The CPU 30 thus displays on the play music notifier section 82 the music related information relating to the music data currently being played. Processing proceeds to step SP49.

In step SP49, the CPU 30 determines whether to quit displaying the music search screen 70. A non-affirmative answer to the determination in step SP49 shows that the user is selecting a desired song using the music search screen 70. In response to the non-affirmative answer, the CPU 30 returns to step SP43.

A non-affirmative answer in the determination in step SP45 shows that any position is selected on the music selection image SDI without the need for the user's intervention to modify the music selection image SDI on the music search screen 70 or shows that the user is viewing the music selection image SDI on the music search screen 70 to determine whether to modify the viewpoint or select the position. In response to the non-affirmative answer, the CPU 30 proceeds to step SP46.

A non-affirmative answer in the determination in step SP46 shows that the user is viewing the music selection image SDI on the music search screen 70 to determine whether to modify the viewpoint or select the position. In response to the non-affirmative answer, the CPU 30 proceeds to step SP49.

In cooperation with the CPU 30 in the data recording and playing apparatus 21, the CPU 60 in the music providing apparatus 22 teaches the user the impression of each of a plurality songs as the location positions of the music indicators SI in the music selection image SDI. When the music indicator SI is selected as the position on the music selection image SDI, the CPU 60 in the music providing apparatus 22 allows the user to listen actually to the selected song indicated by the selected music indicator SI. The CPU 60 thus allows the user to verify whether the song matches (is close to) the user's preference. The CPU 60 in the music providing apparatus 22 thus allows the user to select the song to the user's preference by referring to the location positions of the plurality of music indicators SI on the music selection image SDI and by listening to the song indicated by the music indicator SI.

An affirmative answer to the determination in step SP49 shows that the user has requested to quit displaying the music search screen 70 with the desired song selected by the user. In response to the affirmative answer, the CPU 30 proceeds to step SP50 to end the second display process RT4.

In step SP66, the CPU 60 in the music providing apparatus 22 waits until the transmission of the music data to the data recording and playing apparatus 21 has been completed. Upon completion of the transmission of the music data, the CPU 60 proceeds to step SP67. The first image providing process RT5 is thus completed. The music providing apparatus 22 and data recording and playing apparatus 21 now complete the music selection process.

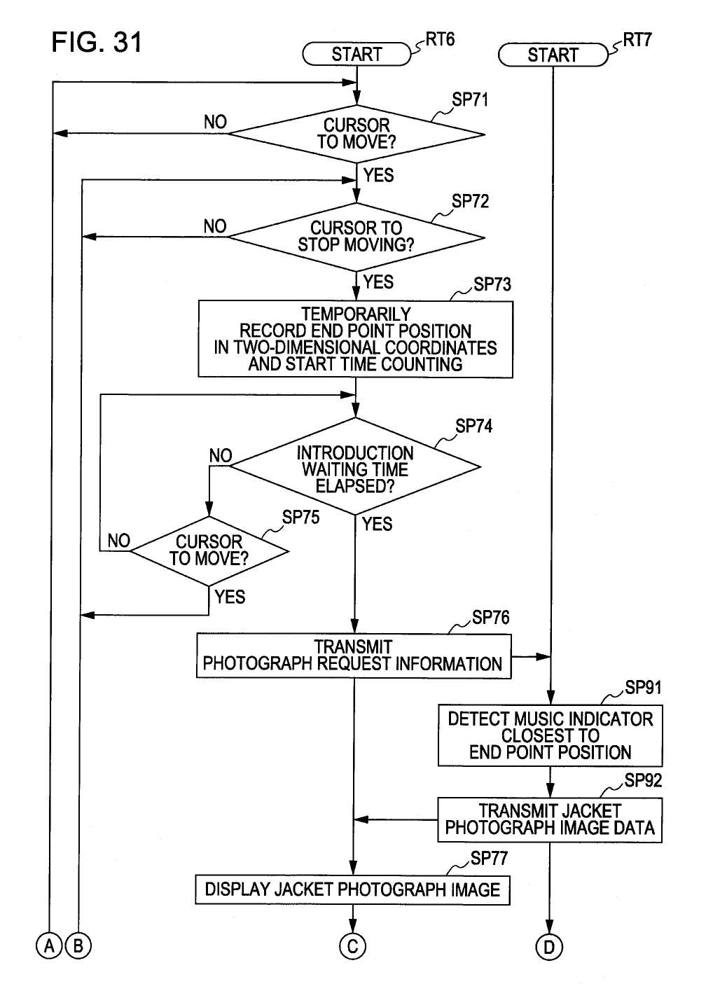

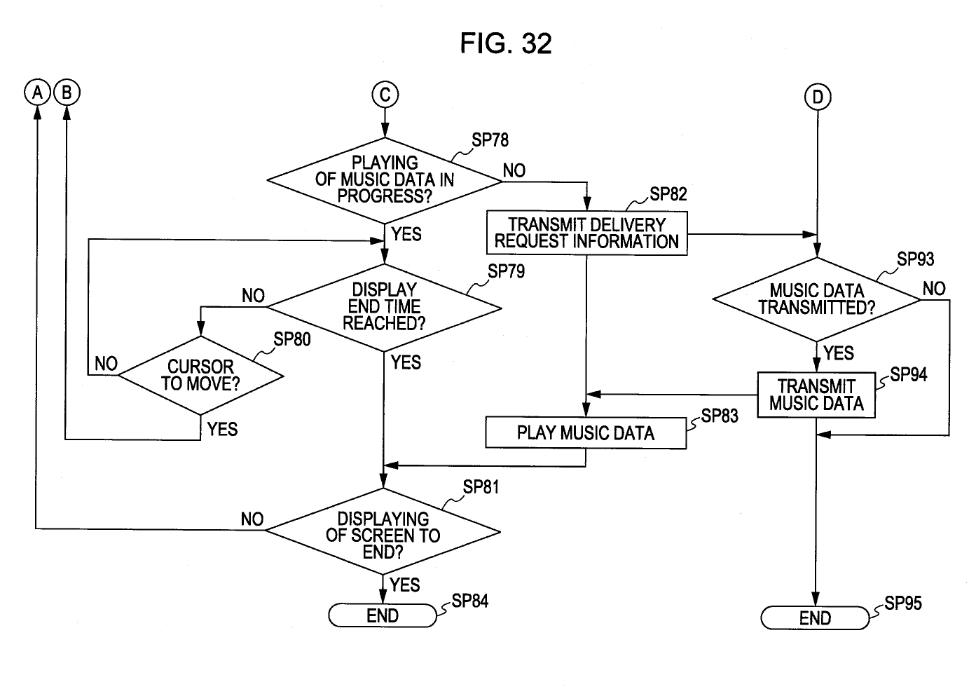

A music introduction process for introducing music to the user is described below with reference to a flowchart of FIGS. 31 and 32. The music providing apparatus 22 performs the music introduction process in cooperation with the data recording and playing apparatus 21. The CPU 30 in the data recording and playing apparatus 21 displays the music search screen 70 supplied from the music providing apparatus 22 on the display 39. The CPU 30 then starts a third display process RT6 of FIGS. 31 and 32 in accordance with the display program. With the third display process RT6 starting, the CPU 30 waits until the user moves the cursor Cu2 on the music selection image SDI (or the music selection expansion image SDW) on the music search screen 70 using the mouse. When the user starts moving the cursor Cu2 on the music selection image SDI (or the music selection expansion image SDW), the CPU 30 proceeds to step SP72.

In step SP72, the CPU 30 waits until the user stops moving the cursor Cu2 on the music selection image SDI (or the music selection expansion image SDW). When the user stops moving the cursor Cu2 on the music selection image SDI (or the music selection expansion image SDW) using the mouse, the CPU 30 proceeds to step SP73. In step SP73, the CPU 30 temporarily stores the two-dimensional coordinates at the end point position of the cursor Cu2 at the moment the cursor Cu2 stops moving on the music selection image SDI (or the music selection expansion image SDW) and starts time counting with the timer. Processing proceeds to step SP74.

In step SP74, the CPU 30 determines whether the introduction waiting time has elapsed on the timer. If it is determined in step SP74 that the introduction waiting time has not elapsed, processing to step SP75. In step SP75, the CPU 30 determines whether to move the cursor Cu2 on the music selection image SDI (or the music selection expansion image SDW). An affirmative answer in the determination in step SP75 shows that the user had operated the mouse to start moving the cursor Cu2 on the music selection image SDI (or the music selection expansion image SDW) when the introduction waiting time elapsed. In response to the affirmative answer, the CPU 30 returns to step SP72.

A non-affirmative answer to the determination in step SP75 shows that the user has not operated the mouse since the stop of the movement of the cursor Cu2 on the music selection image SDI (or the music selection expansion image SDW) since the stop of the movement of the cursor Cu2. In response to the non-affirmative answer, the CPU 30 returns to step SP74. The CPU 30 monitors the timer as to whether the introduction waiting time has elapsed with the cursor Cu2 remaining stationary since the stop of the cursor Cu1 on the music selection image SDI (or the music selection expansion image SDW).

An affirmative answer to the determination in step SP74 shows that the introduction waiting time has elapsed on the timer with the cursor Cu2 remaining stationary since the stop of the movement of the cursor Cu2 on the music selection image SDI (or the music selection expansion image SDW). In response to the affirmative answer, the CPU 30 proceeds to step SP76. In step SP76, the CPU 30 transmits photograph request information requesting the jacket photograph image data to the music providing apparatus 22 and proceeds to step SP77. The photograph request information indicates the three-dimensional coordinates at the end point position of the cursor Cu2 stopping on the music selection image SDI (or the music selection expansion image SDW).

When communication is established with the data recording and playing apparatus 21, the CPU 60 in the music providing apparatus 22 starts a second image providing process RT7 of FIGS. 31 and 32 in accordance with the image providing program. With the second image providing process RT7 starting, the CPU 60 receives the photograph request information from the data recording and playing apparatus 21 in step SP91. The CPU 60 detects the music indicator SI closest to the end point position based on the two-dimensional coordinates at the end point position indicated by the photograph request information and the two-dimensional coordinates of the plurality of music indicators SI within the music selection image SDI (or the music selection expansion image SDW) then provided to the data recording and playing apparatus 21. Processing proceeds to step SP92. In step SP92, the CPU 60 reads from the hard disk drive 62 the jacket photograph image data corresponding to the detected music indicator SI and transmits the read jacket photograph image data to the data recording and playing apparatus 21. Processing proceeds to step SP93.

In step SP77, the CPU 30 in the data recording and playing apparatus 21 receives the jacket photograph image data from the music providing apparatus 22 and supplies the received jacket photograph image data to the display 39. The CPU 30 overlays the jacket photograph image 87 on the music selection image SDI (or the music selection expansion image SDW) on the music search screen 70 of the display 39. Processing proceeds to step SP78.

When the jacket photograph image 87 is overlaid on the music selection image SDI (or the music selection expansion image SDW), the CPU 30 determines in step SP78 whether another unit of music data different from the music data corresponding to the jacket photograph image 87 is being played. An affirmative answer to the determination in step SP78 shows that the user had moved the cursor Cu2 on the music selection image SDI (or the music selection expansion image SDW) using the mouse in the middle of playing one of the selected song or the plurality of candidate songs when the cursor Cu2 stopped moving. In response to the affirmative answer, the CPU 30 proceeds to step SP79.

In step SP79, the CPU 30 determines whether the timer has reached the display end time. The timer starts timing counting at the beginning of the displaying of the jacket photograph image 87. If the timer has not reached the display end time, the CPU 30 proceeds to step SP80 with the jacket photograph image 87 remaining displayed. In step SP80, the CPU 30 determines whether to move the cursor Cu2 on the music selection image SDI (or the music selection expansion image SDW). An affirmative answer to the determination in step SP80 shows that the user operates the mouse within a period from the display start time to the display end time of the jacket photograph image 87 and thus starts moving the cursor Cu2 on the music selection image SDI (or the music selection expansion image SDW). In response to the affirmative answer, the CPU 30 forces the music search screen 70 to quit displaying the jacket photograph image 87 and returns to step SP72.

A non-affirmative answer to the determination in step SP80 shows that the user has not operated the mouse since the display start time of the jacket photograph image 87. In response to the non-affirmative answer, the CPU 30 returns to step SP79 with the jacket photograph image 87 remaining displayed. The CPU 30 monitors whether the timer has reached the display end time with the cursor Cu2 remaining stationary since the display start time of the jacket photograph image 87. An affirmative answer to the determination in step SP79 shows that the timer has reached the display end time with the cursor Cu2 remaining stationary. In response to the affirmative answer, the CPU 30 quits displaying the jacket photograph image 87 and proceeds to step SP81.

In step SP81, the CPU 30 determines whether to quit displaying the music search screen 70. A non-affirmative answer to the determination in step SP81 shows that the user is now selecting a desired song using the music search screen 70. In response to the non-affirmative answer, the CPU 30 returns to step SP71. A non-affirmative answer to the determination in step SP78 shows that the user stops moving the cursor Cu2 after moving the cursor Cu2 on the music selection image SDI (or the music selection expansion image SDW) using the mouse with no music data played. In response to the non-affirmative answer, the CPU 30 proceeds to step SP82. In step SP82, the CPU 30 transmits to the music providing apparatus 22 the delivery request information requesting to deliver the music data corresponding to the jacket photograph image 87. Processing proceeds to step SP83.

In step SP93, the CPU 60 in the music providing apparatus 22 determines whether to transmit to the data recording and playing apparatus 21 the music data corresponding to the jacket photograph image 87. A non-affirmative answer to the determination in step SP93 shows that no music data is played when the data recording and playing apparatus 21 displays the jacket photograph image 87 (i.e., no music data is supplied from the music providing apparatus 22). In response to the affirmative answer, the CPU 60 proceeds to step SP94.

In step SP94, the CPU 60 reads from the hard disk drive 62 the music data corresponding to the delivery request information received from the data recording and playing apparatus 21, extracts the characteristic portion from the read music data and transmits the characteristic portion to the data recording and playing apparatus 21. The CPU 60 also reads from the hard disk drive 62 the music related information and transmits the read music related information to the data recording and playing apparatus 21. The CPU 60 proceeds to step SP95 to end the second image providing process RT7.

A non-affirmative answer to the determination in step SP93 shows that the jacket photograph image 87 is being displayed when the music data is played on the data recording and playing apparatus 21 (i.e., the music data is being supplied from the music providing apparatus 22). In response to the non-affirmative answer, the CPU 60 proceeds to step SP95. In step SP95, the CPU 60 ends the second image providing process RT7 without supplying the music data to the data recording and playing apparatus 21.

In step SP83, the CPU 30 in the data recording and playing apparatus 21 receives the characteristic portion of the music data transmitted from the music providing apparatus 22 while playing the characteristic portion at the same time. The CPU 30 receives the music related information from the music providing apparatus 22 while supplying the music related information to the display 39 at the same time. The CPU 30 displays on the play music notifier section 82 the music related information corresponding to the music data currently being played and proceeds to step SP81. An affirmative answer to the determination in step SP81 shows that the user has requested to quit displaying the music search screen 70 with the desired song selected. In response to the affirmative answer, the CPU 30 proceeds to step SP84 to end the third display process RT6. The music providing apparatus 22 and data recording and playing apparatus 21 fully complete the music introduction process.

With the above arrangement, the CPU 30 in the data recording and playing apparatus 21 analyzes a plurality of units of music data recorded on the hard disk drive 33. The CPU 30 in the data recording and playing apparatus 21 digitizes each of the three types of impression per song based on the music data, sets the resulting first through third impression values SP, EL and NE as the three-dimensional coordinates, and generates the three-dimensional image TDI in which each music indicator SI representing a song is assigned to each of the three-dimensional coordinates. The CPU 30 in the data recording and playing apparatus 21 generates a plurality of music selection images SDI composed of two-dimensional images with the three-dimensional image TDI projected onto two-dimensional planes as if viewed from different viewpoints. The music selection image SDI is recorded on the hard disk drive 33 as the music selection image data.

When requested by the user to select music, the CPU 30 in the data recording and playing apparatus 21 reads one unit of the music selection image data from the hard disk drive 33 and displays on the display 39 the music search screen 45 with the music selection image SDI based on the music selection image data contained therewithin. Using the input unit 31, the user may instruct the CPU 30 in the data recording and playing apparatus 21 to modify the viewpoint to view the three-dimensional image TDI. The CPU 30 in the data recording and playing apparatus 21 reads from the hard disk drive 33 the music selection image data with respect to the modified viewpoint selected by the user. The CPU 30 in the data recording and playing apparatus 21 thus switches from the music selection image SDI at the unmodified viewpoint to the music selection image SDI at the modified viewpoint on the music search screen 45 on the display 39.

The data recording and playing apparatus 21 can thus display the prepared music selection image SDI on the display 39. This eliminates the need for generating the music selection image SDI of the two-dimensional images based on the three-dimensional image TDI each time the music search screen 45 is displayed on the music search screen 45 or each time the user modifies the viewpoint to view the three-dimensional image TDI. The data recording and playing apparatus 21 substantially reduces workload involved in displaying and switching on the display 39 the music selection image SDI, the music selection images SDI being composed of the two-dimensional images generated with the three-dimensional image TDI viewed from different viewpoints.

The CPU 60 in the music providing apparatus 22 analyzes a large number of units of music data recorded on the hard disk drive 62. The CPU 60 in the music providing apparatus 22 digitizes each of the three types of impression per song based on the music data, sets the resulting first through third impression values SP, EL and NE as the three-dimensional coordinates, and generates the three-dimensional image TDI in which each music indicator SI representing a song is assigned to each of the three-dimensional coordinates. The CPU 60 in the music providing apparatus 22 generates a plurality of music selection images SDI composed of two-dimensional images with the three-dimensional image TDI projected onto two-dimensional planes as if viewed from different viewpoints. The music selection image SDI is recorded on the hard disk drive 62 as the music selection image data.

In response to a request to display the music search screen 70 from the data recording and playing apparatus 21, the CPU 60 in the music providing apparatus 22 reads one unit of music selection image data from the hard disk drive 62 and transmits the music selection image data as the music search screen data to the data recording and playing apparatus 21. The CPU 60 in the music providing apparatus 22 causes the display 39 in the data recording and playing apparatus 21 to display the music search screen 70 with the music selection image SDI based on the music selection image data set therein. In response to a request to modify the viewpoint to view the three-dimensional image TDI from the data recording and playing apparatus 21, the CPU 60 in the music providing apparatus 22 reads from the hard disk drive 62 the music selection image data with respect to the modified viewpoint selected by the user and transmits the music selection image data to the data recording and playing apparatus 21. The CPU 60 in the music providing apparatus 22 switches from the music selection image SDI at the unmodified viewpoint to the music selection image SDI at the modified viewpoint on the music search screen 70 on the display 39.

The music providing apparatus 22 can thus cause the music selection image SDI to be displayed by transmitting the prepared music selection image data to the data recording and playing apparatus 21. This arrangement eliminates the need for the music providing apparatus 22 to generate the music selection image SDI composed of the two-dimensional images based on the three-dimensional image TDI each time the music search screen data is transmitted to the data recording and playing apparatus 21 or each time the data recording and playing apparatus 21 requests the music providing apparatus 22 to modify the viewpoint to view the three-dimensional image TDI. More specifically, the music providing apparatus 22 allows the display 39 in the data recording and playing apparatus 21 to reduce substantially workload involved in displaying and switching on the display 39 the music selection image SDI, the music selection images SDI being composed of the two-dimensional images generated with the three-dimensional image TDI viewed from different viewpoints.

With the above arrangement, the CPU 30 in the data recording and playing apparatus 21 analyzes a plurality of units of music data. The CPU 30 in the data recording and playing apparatus 21 digitizes each of the three types of impression per song based on the music data, sets the resulting first through third impression values SP, EL and NE as the three-dimensional coordinates, and generates the three-dimensional image TDI in which each music indicator SI representing a song is assigned to each of the three-dimensional coordinates. The CPU 30 in the data recording and playing apparatus 21 generates a plurality of music selection images SDI composed of two-dimensional images with the three-dimensional image TDI projected onto two-dimensional planes as if viewed from different viewpoints. The music selection image SDI is recorded on the hard disk drive 33 as the music selection image data. When the user requests data recording and playing apparatus 21 to modify the viewpoint to view the three-dimensional image TDI using the input unit 31 with the music selection image SDI remaining displayed on the display 39, the data recording and playing apparatus 21 reads from the hard disk drive 33 the music selection image SDI generated with the three-dimensional image TDI viewed from the modified viewpoint and displays the music selection image SDI on the display 39. The data recording and playing apparatus 21 substantially reduces workload involved in displaying and switching on the display 39 the music selection images SDI being composed of the two-dimensional images generated with the three-dimensional image TDI viewed from different viewpoints.

The music providing apparatus 22 digitizes each of the three types of impression per song based on the music data, sets the resulting first through third impression values SP, EL and NE as the three-dimensional coordinates, and generates the three-dimensional image TDI in which each music indicator SI representing a song is assigned to each of the three-dimensional coordinates. The music providing apparatus 22 generates a plurality of music selection images SDI composed of two-dimensional images with the three-dimensional image TDI projected onto two-dimensional planes as if viewed from different viewpoints. The music selection image SDI is recorded on the hard disk drive 62 as the music selection image data. The data recording and playing apparatus 21 may request the music providing apparatus 22 to modify the viewpoint to view the three-dimensional image TDI with the music selection image SDI supplied to the data recording and playing apparatus 21. In response, the music providing apparatus 22 reads from the hard disk drive 62 the music selection image SDI generated with the three-dimensional image TDI viewed from the viewpoint modified at the request. The music providing apparatus 22 transmits the generated music selection image SDI to the data recording and playing apparatus 21 to be displayed. More specifically, the music providing apparatus 22 substantially reduces workload involved in displaying and switching on the display 39 in the data recording and playing apparatus 21 the music selection images SDI being composed of the two-dimensional images generated with the three-dimensional image TDI viewed from different viewpoints. In this way, the music providing apparatus 22 easily presents to the user the music selection image SDI composed of the two-dimensional images respectively representing a plurality of songs.

When a plurality of music selection images SDI, each composed of two-dimensional images, are generated, each of the data recording and playing apparatus 21 and the music providing apparatus 22 expresses the perspective of a plurality of music indicators SI in accordance with the location positions of the plurality of music indicators SI within the three-dimensional image TDI with respect to the viewpoint corresponding to each music selection image SDI. With the plurality of music indicators SI presented in perspective on the music selection image SDI composed the two-dimensional images, each of the data recording and playing apparatus 21 and the music providing apparatus 22 allows the user to recognize the impression of each song represented by the respective music indicator SI. Each of the data recording and playing apparatus 21 and the music providing apparatus 22 thus allows the user to select correctly as the selected position the music indicator SI representing the preferred music on the music selection image SDI.

When the user selects the position on the music selection image SDI, each of the data recording and playing apparatus 21 and the music providing apparatus 22 detects as the selected music indicator SI1 the music indicator SI closest to the selected position. Even if the music indicator SI is not located at the position representing the user's preference on the music selection image SDI (i.e., even if music data matching the user's preference is not recorded), each of the data recording and playing apparatus 21 and the music providing apparatus 22 allows the user to select the music indicator SI representing a song closest as possible to the user's preference. Upon detecting the selected music indicator SI1, each of the data recording and playing apparatus 21 and the music providing apparatus 22 selects, as the candidate music display indicators SI2 through SI11, a plurality of music indicators SI close to the selected music indicator SI1 within the music search region MRA. Each of the data recording and playing apparatus 21 and the music providing apparatus 22 can thus select easily and reliably the music indicators SI representing a plurality of songs closest possible to the user's preference.

Each of the data recording and playing apparatus 21 and the music providing apparatus 22 selects the selected music indicator SI1 and the plurality of candidate music display indicators SI2 through SI11. Each of the data recording and playing apparatus 21 and the music providing apparatus 22 then successively plays the selected music indicator SI1 and the plurality of candidate music display indicators SI2 through SI11. Each of the data recording and playing apparatus 21 and the music providing apparatus 22 allows the user to listen actually to a plurality of songs selected in music selection operation by the user. The user can determine whether the song matches (is close to) the user's own preference. Each of the data recording and playing apparatus 21 and the music providing apparatus 22 allows the user to select the song to the user's preference by presenting the plurality of songs as a set of points such as the music indicators SI rather than by presenting a list of songs to the user.

When the candidate music display indicators SI2 through SI11 are selected, each of the data recording and playing apparatus 21 and the music providing apparatus 22 does not necessarily use all music indicators SI in addition to the selected music indicator SI1 within the three-dimensional image TDI. Based on the selected music indicator SI1 within the three-dimensional image TDI, each of the data recording and playing apparatus 21 and the music providing apparatus 22 detects a substantially smaller music search region MRA and selects the candidate music display indicators SI2 through SI11 within the music search region MRA. When the candidate music display indicators SI2 through SI11 are selected, each of the data recording and playing apparatus 21 and the music providing apparatus 22 substantially reduces involved workload by reducing the number of three-dimensional coordinates of other music indicators SI compared with the three-dimensional coordinates of the selected music indicator SI1. Each of the data recording and playing apparatus 21 and the music providing apparatus 22 fast selects and displays the candidate music display indicators SI2 through SI11 to the user.

In the discussion of the above-referenced embodiments, the user selects the position on the music selection image SDI and the expansion target portion SDA centered on the selected position on the music selection image SDI is detected and expanded. The present invention is not limited to such an arrangement. Alternatively, the music selection image SDI may be partitioned into a plurality of expansion regions, and when the user selects the position on the music selection image SDI, the expansion region containing the selected position may be determined and expanded.

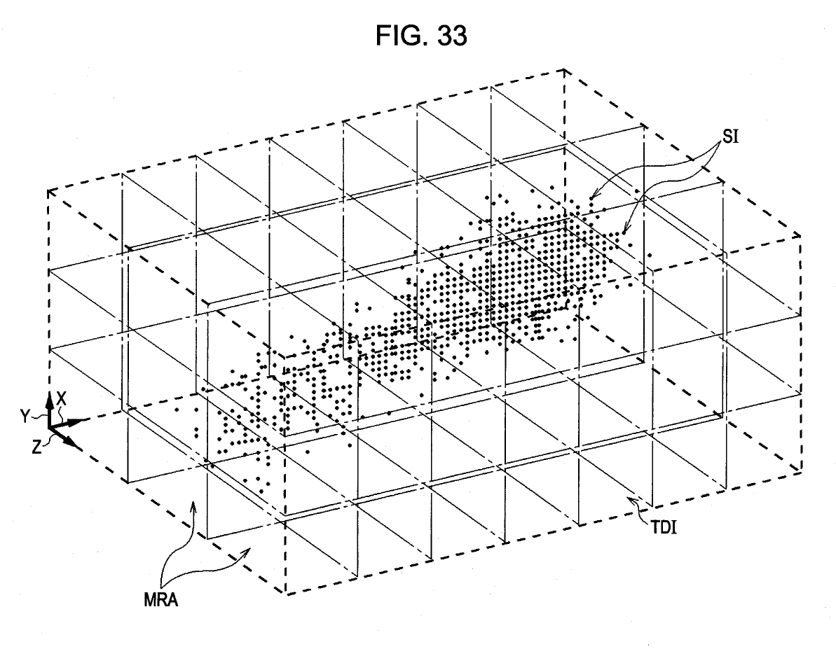

In the above-referenced embodiments, the music search region MRA centered on the location position of the selected music indicator SI1 within the three-dimensional image TDI is detected and used to select the candidate music display indicators SI2 through SI11. Alternatively, the three-dimensional image TDI may be partitioned into a plurality of music search regions MRA as shown in FIG. 33. When the user selects the position on the music selection image SDI, the music search region MRA containing the selected music indicator SI1 corresponding to the selected position may be determined and used to select the candidate music display indicators SI2 through SI11. If the selected music indicator SI1 is close to the border with a neighboring music search region MRA to some degree, the music search region MRA and the neighboring music search region MRA may be used to select the candidate music display indicators SI2 through SI11.

In the above-referenced embodiments, the music data recorded on the hard disk drives 33 and 66 is used to generate a three-dimensional image TDI. Alternatively, a three-dimensional image TDI may be generated on a per category basis, such as genre, artist, and seasons, and a plurality of music selection images SDI with respect to different viewpoints may be generated based on the three-dimensional image TDI.

In the above-referenced embodiments, the data recording and playing apparatus 21 and the music providing apparatus 22 generate and store the three-dimensional image TDI and the plurality of music selection images SDI on the hard disk drives 33 and 62, respectively. Alternatively, the data recording and playing apparatus 21 may record the plurality of music selection images SDI supplied beforehand from the music providing apparatus 22. Furthermore, the music providing apparatus 22 may record on the hard disk drive 62 the plurality of music selection images SDI supplied beforehand from an outside provider of the music data.

In the above-referenced embodiments, with the any position selected on the music selection image SDI, the expansion target portion SDA is expanded as the music selection expansion image SDW and the selected music indicator SI1 and the plurality of candidate music display indicators SI2 through SI11 are selected. Alternatively, the music selection image SDI may be expanded or contracted regardless of the selected position on the music selection image SDI, and any position is selected on the expanded or contracted music selection image SDI.

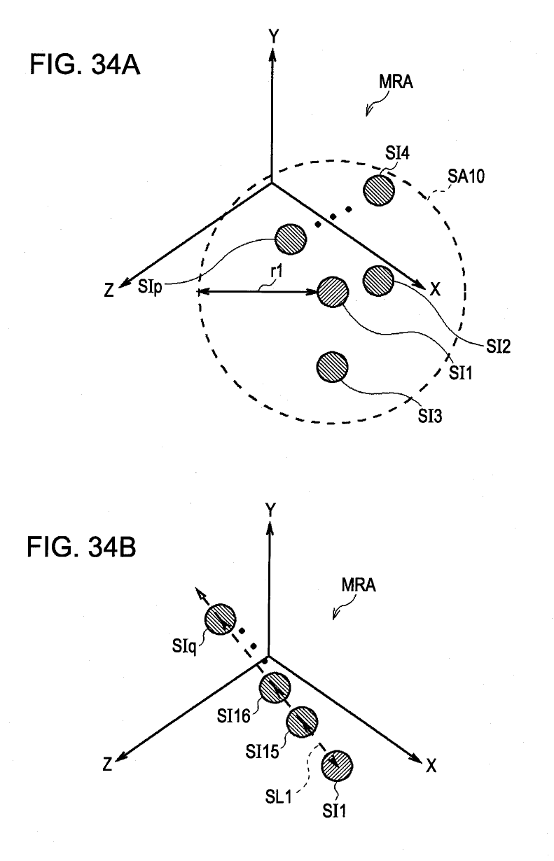

As previously discussed with reference to FIG. 14, the candidate music display indicators SI2 through SI11 of the predetermined standard number are selected in the order from near to far to the selected music indicator SI1 within the music search region MRA. Alternatively, as shown in FIG. 34A, all music display indicators SI2 through SIn present within a spherical selection space SA10 having a predetermined radius r1 centered on the selected music indicator SI1 within the music search region MRA may be selected. As shown in FIG. 14B, music display indicators SI5 through SIq present a selection base line SL1 passing through the selected music indicator SI1 may be selected within the music search region MRA.

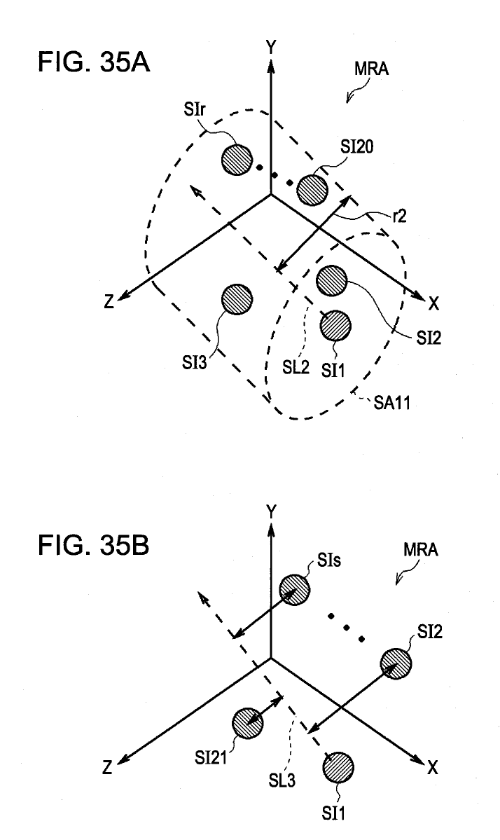

As shown in FIG. 35A, all candidate music display indicators SI1 through SIr present in a cylindrical space SA11 having a predetermined radius r2 and a center axis SL2 passing through the selected music indicator SI1 may be selected as candidate music indicators within the music search region MRA. As shown in FIG. 35B, a selection reference line SL3 passing through the selected music indicator SI1 is set up in the music search region MRA, and music display indicators SI1 through SIs of the standard selection number are selected as candidate music indicators in the order from near to far to the selection reference line SL3.

The plurality of candidate music display indicators SI2 through SI11 are selected with reference to the selected music indicator SI1 in the music search region MRA. Alternatively, the two-dimensional coordinates at the selected position may be expanded onto the three-dimensional coordinates, and one music indicator SI closest to the three-dimensional coordinates may be selected as the selected music indicator SI1. A plurality of music indicators SI may be selected as the candidate music display indicators SI2 through SI11 depending on a predetermined range and distance.

In the above-reference embodiments, the music indicator SI present within the circular area centered on the music indicator SI1 within the music search region MRA is selected as a candidate music indicator. Alternatively, a music indicator SI selected as a candidate music indicator may be present in a disk or any shape in parallel with any of an XY plane, YZ plane and ZX plane centered on the selected music indicator SI1 within the music search region MRA.

As previously discussed with reference to FIG. 14, the candidate music display indicators SI2 through SI11 of the predetermined standard number are selected in the order from near to far to the selected music indicator SI1 within the music search region MRA. Alternatively, only the selected music indicator SI1 is detected (with the candidate music display indicators SI2 through SI11 unselected). Alternatively, a plurality of music indicators SI may be selected with reference to the selected music indicator SI1 as selected music indicators.

In the above-referenced embodiments, the user selects any position on the music selection image SDI. Alternatively, the user may select an area having a predetermined shape such as a circle on the music selection image SDI. For example, the user may draw a circle, an ellipse, a rectangle, etc. as a track of the cursor Cu1 or Cu2 on the music selection image SDI and music indicators SI present within the outline of such a shape may be selected as candidate music indicators. If a plurality of music indicators SI are selected from within the outline of the shape drawn by the user, the data recording and playing apparatus 21 may produce a list listing all of the plurality of registered music indicators SI. The data recording and playing apparatus 21 may allow the user to select and play any song registered in the list in accordance with the user's own preference to impression.

In the above-referenced embodiments of the present invention, the music data is analyzed to digitize the three types of items, such as tempo, tone and age representing the impression of music and the first through third impression values SP, EL and NE are thus obtained. Alternatively, each of the three types of item may be a combination of factors, such as mood. For example, mood may be a combination of tempo, merriness, tune and exhilaration, and then the first through third impression values may be obtained.

In the above-referenced embodiments of the present invention, each of the data recording and playing apparatus 21 and the music providing apparatus 22 generates a plurality of music selection images SDI with respect to a plurality of preset viewpoints. Alternatively, each of the data recording and playing apparatus 21 and the music providing apparatus 22 generates beforehand some of a large number of music selection images SDI with respect to all selectable viewpoints. If the music selection image SDI with respect to a viewpoint selected by the user is already generated, that music selection image SDI is displayed. If the music selection image SDI with respect to a viewpoint selected by the user is not generated, each of the data recording and playing apparatus 21 and the music providing apparatus 22 generates, displays and stores the corresponding music selection image SDI. At first, each of the data recording and playing apparatus 21 and the music providing apparatus 22 stores a relatively small number of music selection images SDI, and then gradually accumulates the music selection images SDI each time new viewpoint is selected by the user. The music selection image is not necessarily generated each time the music selection process is performed, each time the displaying of the music search screen 45 and the music search screen 70 starts or each time the viewpoint is modified. Increase in workload is thus controlled.

In the above-referenced embodiments of the present invention, the display program pre-recorded on one of the ROM 32 and the hard disk drive 33 in the data recording and playing apparatus 21 is used. The CPU 30 executes the image generation process RT1, the first through third display processes RT2, RT4 and RT6 and the music introduction process RT3 in accordance with the display program with reference to FIGS. 27-32. The present invention is not limited to this arrangement. Alternatively, a program storage medium storing the display program may be installed onto the data recording and playing apparatus 21 and the data recording and playing apparatus 21 executes the image generation process RT1, the first through third display processes RT2, RT4 and RT6 and the music introduction process RT3.

The program storage medium is used to install the display program to the data recording and playing apparatus 21 to execute the image generation process RT1, the first through third display processes RT2, RT4 and RT6 and the music introduction process RT3. Such a program storage medium may be a package medium such as a flexible disk, a compact disk read-only memory (CD-ROM), and a digital versatile disk (DVD). The program storage medium may be a semiconductor memory or a magnetic disk, each storing a variety of programs temporarily or permanently. Means for storing the display program on the program storage medium may include a wired communication medium such as a local area network, and the Internet and a wireless communication medium such as a digital broadcasting satellite. The means further include a communication interface such as a router or modem.

In the above-referenced embodiments of the present invention, the image providing program pre-recorded on one of the ROM 61 and the hard disk drive 62 in the music providing apparatus 22 is used. The CPU 60 executes the image generation process RT1, and the first and second image providing processes RT5 and RT7 with reference to FIG. 27 and FIGS. 30-32 in accordance with the image providing program. The present invention is not limited to this arrangement. Alternatively, a program storage medium storing the image providing program may be installed onto the music providing apparatus 22 and the music providing apparatus 22 executes the image generation process RT1, and the first and second image providing processes RT5 and RT7.

The program storage medium is used to install the image providing program to the music providing apparatus 22 to execute the image generation process RT1, and the first and second image providing processes RT5 and RT7. Such a program storage medium may be a package medium such as a flexible disk, a CD-ROM, and a DVD. The program storage medium may be a semiconductor memory or a magnetic disk, each storing a variety of programs temporarily or permanently. Means for storing the display program on the program storage medium may include a wired communication medium such as a local area network, and the Internet and a wireless communication medium such as a digital broadcasting satellite. The means further include a communication interface such as a router or modem.

In the above-referenced embodiments of the present invention, the display apparatus is applied to one of the display apparatus 1 and the data recording and playing apparatus 21 as a personal computer as discussed with reference to FIGS. 1 through 35. Alternatively, the display apparatus is applicable to information processing apparatuses including a cellular phone, and a personal digital assistant (PDA), and recording and playing apparatuses including a video camera, a digital still camera, a DVD recorder, and a hard disk recorder.

In the above-referenced embodiments of the present invention, the image providing apparatus is applied to one of the image providing apparatus 10 and the music providing apparatus 22 as discussed with reference to FIGS. 1 through 35. Alternatively, the image providing apparatus is applicable to information processing apparatuses including a cellular phone, and a personal digital assistant (PDA), and recording and playing apparatuses including a video camera, a digital still camera, a DVD recorder, and a hard disk recorder.

In the above-referenced embodiments of the present invention, music is used as the content as discussed with reference to FIGS. 1 through 35. Alternatively, the present invention is applicable to other types of contents including a photograph, a moving image such as movie, and a game playing program.

In the above-referenced embodiments of the present invention, the first through third impression values obtained by digitizing three types of items representing the impression of each content are set as the three-dimensional coordinates. The three-dimensional image is generated with the content indicator indicating the content arranged in the three-dimensional coordinates. The plurality of two-dimensional images are generated with the three-dimensional image viewed from different viewpoints. The plurality of three-dimensional images are recorded on a recording unit. Such a recording unit may be one of the recorder 2 of the display apparatus 1, the hard disk drive 33 of the data recording and playing apparatus 21, the recorder 11 of the image providing apparatus 10, and the hard disk drive 62 of the music providing apparatus 22. Alternatively, the recording unit may be a semiconductor memory internal thereto or external thereto, or a drive using an optical disk.

In the above-referenced embodiments of the present invention, the display for displaying the two-dimensional image recorded on the recorder may be one of the display 3 of the display apparatus and the display 39 of the data recording and playing apparatus 21 discussed with reference to FIGS. 1 through 35. Alternatively, the display may be a external television receiver.

In the above-referenced embodiments of the present invention, the pointer for modifying the viewpoint to view the three-dimensional image is one of the pointer 4 in the display apparatus and the input unit 31 of the data recording and playing apparatus 21. Alternatively, the pointer may be one of a variety of pointers including a variety of pointing devices including an operation key to be pressed, a touchpanel, and a joystick.

In the above-referenced embodiments of the present invention, the two-dimensional image generated with the three-dimensional image viewed from a predetermined viewpoint is read from the recorder. The user may instruct the pointer to modify the viewpoint with the read two-dimensional image displayed. A display controller reads from the recorder the two-dimensional image generated with the three-dimensional image viewed from the modified viewpoint and displays the read two-dimensional image on the display. Such a display controller is one of the display controller 5 of the display apparatus 1 and the CPU 30 in the data recording and playing apparatus 21 as described with reference to FIGS. 1 through 35. Alternatively, the display controller may be a microcomputer.

In the above-referenced embodiments of the present invention, the selector for selecting any position within the two-dimensional image displayed on the display is the input unit 31 in the data recording and playing apparatus 21 discussed with reference to FIGS. 1 through 35. Alternatively, the selector may be one of a variety of pointing devices including an operation key to be pressed, a touchpanel, and a joystick.

In the above-referenced embodiments of the present invention, the detector detects the content indicator at a position closest to the selected position on the two-dimensional image when the selector selects the position on the two-dimensional image. Such a detector is the CPU 30 in the data recording and playing apparatus 21 discussed with reference to FIGS. 1 through 35. Alternatively, the detector may be a microcomputer.

In the above-referenced embodiments of the present invention, the player for playing the content corresponding to the content indicator includes the playing processor 37 and the loudspeaker 38 in the data recording and playing apparatus 21 discussed with reference to FIGS. 1 through 35. Alternatively, the player may be a central processing unit or a display depending on content.

In the above-referenced embodiments of the present invention, the transmitter for transmitting the two-dimensional image recorded on the recorder to an external device displaying the two-dimensional image is one of the transmitter 12 of the image providing apparatus 10 and the network interface 64 of the music providing apparatus 22 discussed with reference to FIGS. 1 through 35. Alternatively, the transmitter may include an antenna for radio communication and a modulator.

In the above-referenced embodiments of the present invention, the receiver for receiving request information requesting to modify the viewpoint to view the three-dimensional image is one of the receiver 14 of the image providing apparatus 10 and the network interface 64 of the music providing apparatus 22 discussed with reference to FIGS. 1 through 35. Alternatively, the receiver may include an antenna for radio communication and a demodulator.

In the above-referenced embodiments of the present invention, the transmission controller reads from the recorder the two-dimensional image generated with the three-dimensional image viewed from the predetermined viewpoint and controls a transmitter to transmit the read two-dimensional image to an external device. When the receiver receives request information transmitted from the external device displaying the two-dimensional image, the transmission controller reads from the recorder the two-dimensional image generated with the three-dimensional image viewed from the modified viewpoint indicated by the requested information received by the receiver. The transmission controller controls the transmitter to transmit the read two-dimensional image to the external device. The transmission controller is one of the transmission controller 15 in the image providing apparatus 10 and the CPU 60 in the music providing apparatus 22 with reference to FIGS. 1 through 35. Alternatively, the transmission controller may be a microcomputer.

In the above-referenced embodiments of the present invention, the detector detects a content indicator at a position closest to a position selected within the two-dimensional image. The detector is the CPU 60 in the music providing apparatus 22 discussed with reference to FIGS. 1 through 35. Alternatively, the detector may be a microcomputer.

It should be understood by those skilled in the art that various modifications, combinations, sub-combinations and alterations may occur depending on design requirements and other factors insofar as they are within the scope of the appended claims or the equivalents thereof.

What is claimed is:

1. A display apparatus comprising:
a recorder for recording a plurality of two-dimensional images that are obtained with a three-dimensional image viewed from different viewpoints, the three-dimensional image having a plurality of content indicators representing contents and arranged in three-dimensional coordinates representing first through third impression values of impression at each content;
a display for displaying the two-dimensional image recorded on the recorder;
a pointer for pointing to the viewpoint for modification to view the three-dimensional image; and
a display controller for reading from the recorder one of two-dimensional images with the three-dimensional image viewed from one viewpoint, reading from the recorder another two-dimensional image with the three-dimensional image viewed from another viewpoint in response to an operation input entered to the pointer with the read two-dimensional image being displayed on the display, and displaying the other read two-dimensional image on the display.

2. The display apparatus according to claim 1, wherein the recorder records the plurality of two-dimensional images when the three dimensional image is viewed from different viewpoints with the plurality of content indicators made different in a display mode in accordance with distance perspective thereof.

3. The display apparatus according to claim 2, further comprising a detector for detecting a content indicator located closest to a position within the two-dimensional image displayed on the display, the position being selected in response to the operation input to the pointer.

4. The display apparatus according to claim 3, wherein the display controller causes the display to display a predetermined portion of the two-dimensional image containing the content indicator detected by the detector.

5. The display apparatus according to claim 3, further comprising a player for playing the content,
wherein the detector detects within the three-dimensional image a location position of the content indicator detected within the two-dimensional image, and detects another content indicator located within a predetermined space containing the location position of the detected content indicator within the three-dimensional image, and
wherein the player plays a content corresponding to the content indicator detected within the two-dimensional image and the other content indicator detected in the predetermined space within the three-dimensional image.

6. A display method comprising steps of:
recording a plurality of two-dimensional images that are obtained with a three-dimensional image viewed from different viewpoints, the three-dimensional image having a plurality of content indicators representing contents and arranged in three-dimensional coordinates representing first through third impression values of impression at each content;
displaying the two-dimensional image;
pointing to the viewpoint for modification to view the three-dimensional image; and
in response to an instruction to modify the viewpoint with one of two-dimensional images displayed with the three-dimensional image viewed from one viewpoint, causing another two-dimensional image to be displayed with the three-dimensional image viewed from another viewpoint.

7. The display method according to claim 6, wherein the plurality of two-dimensional images are obtained when the three dimensional image is viewed from different viewpoints with the plurality of content indicators made different in a display mode in accordance with distance perspective thereof.

8. The display method according to claim 7, further comprising a step of detecting a content indicator located closest to a position within the two-dimensional image, the position being selected in response to an operation input.

9. The display method according to claim 8, further comprising a step of displaying a predetermined portion of the two-dimensional image containing the detected content indicator.

10. The display method according to claim 8, wherein the step of detecting the content indicator comprising:
detecting within the three-dimensional image a location position of the content indicator detected within the two-dimensional image, and detecting another content indicator located within a predetermined space containing the location position of the detected content indicator within the three-dimensional image, and
wherein a content corresponding to the content indicator detected within the two-dimensional image and the other content indicator detected within the predetermined space within the three-dimensional image is played.

11. A computer-readable recording medium storing a computer program, the computer program for causing a computer to perform steps of:
recording a plurality of two-dimensional images that are obtained with a three-dimensional image viewed from different viewpoints, the three-dimensional image having a plurality of content indicators representing contents and arranged in three-dimensional coordinates representing first through third impression values of impression at each content;
displaying the two-dimensional image; and
in response to an instruction to modify the viewpoint with one of two-dimensional images displayed with the three-dimensional image viewed from one viewpoint, causing another two-dimensional image to be displayed with the three-dimensional image viewed from another viewpoint.

12. The recording medium according to claim 11, wherein the plurality of two-dimensional images are obtained when the three dimensional image is viewed from different viewpoints with the plurality of content indicators made different in a display mode in accordance with distance perspective thereof.

13. The recording medium according to claim 12, wherein the computer program further comprises a step of detecting a content indicator located closest to a position within the two-dimensional image, the position being selected in response to an operation input.

14. The recording medium according to claim 13, wherein the computer program further comprises a step of displaying a predetermined portion of the two-dimensional image containing the detected content indicator.

15. The recording medium according to claim 13, wherein the step of detecting the content indicator comprising:
detecting within the three-dimensional image a location position of the content indicator detected within the two-dimensional image, and detecting another content indicator located within a predetermined space containing the location position of the detected content indicator within the three-dimensional image, and
wherein a content corresponding to the content indicator detected within the two-dimensional image and the other content indicator detected within the predetermined space within the three-dimensional image is played.

16. An image providing apparatus comprising:
a recorder for recording a plurality of two-dimensional images that are obtained with a three-dimensional image viewed from different viewpoints, the three-dimensional image having a plurality of content indicators representing contents and arranged in three-dimensional coordinates representing first through third impression values of impression at each content;
a communicator for communicating with an external device; and
a controller for reading from the recorder one of two-dimensional images with the three-dimensional image viewed from one viewpoint, causing the communicator to transmit the one of two-dimensional images to the external device, reading from the recorder another two-dimensional image with the three-dimensional image viewed from another viewpoint if the communicator receives an operation input from the external device with the read two-dimensional image being displayed on a display, and causing the communicator to transmit to the external device the other read two-dimensional image.

17. An image providing method comprising steps of:
recording a plurality of two-dimensional images that are obtained with a three-dimensional image viewed from different viewpoints, the three-dimensional image having a plurality of content indicators representing contents and arranged in three-dimensional coordinates representing first through third impression values of impression at each content;
transmitting to an external device one of the two-dimensional images with the three-dimensional image viewed from one viewpoint; and
transmitting to the external device another two-dimensional images with the three-dimensional image viewed from another viewpoint if an operation input is received with the two-dimensional image displayed.

18. A computer-readable recording medium storing a computer program for causing a computer to perform steps of:
recording a plurality of two-dimensional images that are obtained with a three-dimensional image viewed from different viewpoints, the three-dimensional image having a plurality of content indicators representing contents and arranged in three-dimensional coordinates representing first through third impression values of impression at each content;
transmitting to an external device one of the two-dimensional images with the three-dimensional image viewed from one viewpoint; and
transmitting to the external device another two-dimensional images with the three-dimensional image viewed from another viewpoint if an operation input is received with the two-dimensional image displayed.
